(19) United States
(12) Patent Application Publication
(10) Pub. No.: US 2014/0024436 A1
(43) Pub. Date: Jan. 23, 2014

(54) SCHEDULING AND MARKETING OF CASINO TOURNAMENTS

(71) Applicant: DeVona Cole, Mission Viejo, CA (US)

(72) Inventor: DeVona Cole, Mission Viejo, CA (US)

(21) Appl. No.: 13/737,635

(22) Filed: Jan. 9, 2013

Related U.S. Application Data
(63) Continuation of application No. 12/545,831, filed on Aug. 23, 2009, now abandoned.

(51) Int. Cl. G07F 17/32

(52) U.S. Cl. CPC G07F 17/3276
USPC 463/25

(57) ABSTRACT

Systems, methods and apparatus for scheduling of casino tournaments are provided. In one embodiment, the method includes providing at least one casino member the ability to create an account or register to provide casino tournament information over a computer network and a log-in screen; receiving information regarding a plurality of casino tournaments offered by the casino members, providing schedulers to upload the plurality of casino tournaments by the casino members based on pre-specified criteria, providing the potential player or player the ability to search the plurality of casino tournaments offered by the casino members based on a pre-specified criteria, providing the results of a search of the casino tournaments from the search requested from the players or potential players and providing the players or potential players with the ability to calendar/schedule at least one or more casino tournaments in their personal calendar.

### BACKGROUND OF THE INVENTION

1. Field of the Invention

The present invention relates generally to the field of electronic scheduling management, and more particularly, to methods, systems and apparatus for managing and providing casino tournament schedules and marketing of casino tournaments over a computer network.

2. Background

Casinos and gambling have grown increasingly popular, as the demand for the wagering games has grown and games of skill and chance have become more and more popular. Casinos provide facilities and organize wagering games for a profit. Examples of the wagering games include, but are not limited to, poker, blackjack, baccarat, roulette, slot machines and craps. The wagering games are also available in online casinos, where permitted by law. In addition to providing facilities for wagering games, casinos hold wagering game tournaments, also known as casino tournaments. For example, in a poker tournament, the winners are decided by playing poker, usually a particular style of poker. To enter a typical poker tournament, a player pays a fixed buy-in and at the start of play is given a certain quantity of tournament poker chips. The player is then provided with a seat in the poker tournament selected randomly by the casino. The casino typically makes money on the tournament and the activities that are associated with the tournament. Tournaments also encourage gambling generally, including traditional non-tournament based casino gambling, which can be a significant source of profit for casinos. Tournament participants also add to the casino's hotel, restaurant, show and other non-gambling related profit. Accordingly, casinos have an interest in attracting players and providing successful tournaments.

Typically, a player either calls up or visits the individual casinos to find out the tournaments scheduled in the casino and then determine if they want to reserve a seat for that particular casino tournament. The player has to spend a lot of time and physical effort in finding out all casino tournament information in which he or she may be interested. Further, the player is generally not aware of all the tournaments and if there are other tournaments that are more convenient to him in terms of location, date, price and/or time.

In some cases, the seat for a casino tournament can be booked through the website of the casino. The player can see all the tournaments scheduled by the casino and select a tournament. In that case, the player has to visit the website of each casino individually and find out a tournament he is interested in and call those that do not provide the information on the website. Further, the player will not have the knowledge of all the casinos in a particular geography. The player cannot easily compare the different casino tournaments and decide the most suitable tournament in terms any combination of factors, including but not limited to date, time, location, rules, prizes, players, types of games and fee for participation in the tournament.

Casinos typically depend on word of mouth and referrals to promote their casinos and rely on old traditional methods of marketing to make players aware of their tournaments. These forms of advertising and marketing are inefficient and often do not reach the desired group of people. Generally speaking, poker Magazines are not available at all casinos and only advertise the clients that pay them to advertise in there publication. Their marketing also has limitations in that it typically does not reach all potential players world-wide. Hence, the casinos are not able to publicize and market their tournaments to the desired pool of people.

In the light of the foregoing discussion, there is a need for a methods, apparatus and systems for allowing casino's to manage and provide schedules of multiple casino tournaments in one place which provides numerous benefits and advantages. Further, the methods, apparatus and systems should allow players to search for all casino tournament schedules at one place, provide various benefits for all users who use the scheduling system and should allow the casinos to market their tournaments to the desired group of people and provide other advantages inherent to the methods, apparatus and systems.

### SUMMARY OF THE INVENTION

It is an object of the present invention to provide methods, apparatus and systems for managing the schedules of multiple tournaments for multiple casinos in one place.

It is yet another object of the present invention to provide methods, apparatus and systems for allowing the casinos to market their tournaments to a desired group of people.

It is yet another object of the present invention to provide methods, apparatus and systems for online tournament schedules that provides the player interested in joining one or more tournaments various benefits and advantages, including but not limited to, the ability to obtain and compare information regarding various different tournaments in a way that is advantageous to the user, being able to calendar and schedule for various tournaments at once or certain strategic tournament and modify options or aspects of the tournaments they participate in.

It is yet another object of the present invention to provide methods, apparatus and systems for online tournament schedules that provide a quick and simple way for a casino employee to enter information about a poker tournament and communicate the information to their intended audience, the desired tournament players.

It is yet another object of the present invention to provide methods, apparatus and systems for online tournament schedules that provide a calendar that gives the casino employee the ability to view all their current, future, and past tournament schedules.

It is yet another object of the present invention to provide methods, apparatus and systems for online tournament schedules that provides a competition calendar that allows casino employees to view competitors current, future, and past tournament schedules, enabling them to make better scheduling decisions when planning their own events (tournament or otherwise).

It is yet another object of the present invention to provide methods, apparatus and systems for online tournament schedules with search functions that allows both tournament players and casino employees to find all current, future and past poker tournaments across the world.

It is yet another object of the present invention to provide methods, apparatus and systems and the casino employee to calculate tournament payout.

It is yet another object of the present invention to provide methods, apparatus and systems for online tournament schedules where players can search and find the best poker tournament for their own selected specifications.

It is yet another object of the present invention to provide methods, apparatus and systems for online tournament schedules where tournament players have access to a calendar that allows a player to track their current, future, and past tournament play.

It is yet another object of the present invention to provide methods, apparatus and systems for online tournament schedules where players can find all current, future and past poker tournaments anywhere in the world based on a variety of factors (e.g., within a certain city or a zip code or within a certain distance from a particular location). and track and report a player's bankroll (wins and losses).

The above and other objects of the present invention are achieved by providing methods, apparatus and systems for managing schedules of one or more casino tournaments over a computer network, wherein the computer network provides interaction between one or more casino members and one or more players. In at least one embodiment, a schedule is provided by the one or more casino members to the one or more players, where the schedule is provided for participation in the one or more casino tournaments.

In an embodiment of the present invention, a method for managing schedules of one or more casino tournaments over a computer network is provided. The method comprises providing at least one casino member of the one or more casino members the ability to create an account or register to provide casino tournament information over a computer network, providing at least one casino member of the one or more casino members with a log-in screen on one or more visual displays, receiving information regarding a plurality of casino tournaments offered by the one or more casino members from the one or more casino members, the information being provided by the at least one casino member over a computer network, providing the at least one player of the one or more players the ability to search the plurality of casino tournaments offered by the one or more casino members based on a pre-specified criteria over a computer network, the pre-specified criteria being selected by the at least one player, providing the results of a search of the one or more casino tournaments from the search requested from the at least one or more players on a visual display or computer readable medium, the results being provided based on the search requested by the one or more pre-specified criteria selected by the at least one or more players and providing the at least one or more player with the ability to calendar/schedule one or more casino tournaments provided in the requested search.

In an aspect of at least one embodiment of the present invention, the one or more casino members create an account or register to provide casino tournament information over a computer network at least once before receiving information regarding a plurality of casino tournaments offered by the one or more casino members from the one or more casino members and the schedule is provided for the at least one or more players to participate in the one or more casino tournaments offered by the one or more casino members.

In an aspect of at least one embodiment of the present invention, the one or more casino members create a tournament schedule using the first casino scheduler to enter tournament detail for a specific tournament event. The first casino scheduler being the special event scheduler.

In yet another aspect of at least one embodiment of the present invention the one or more casino members create a tournament schedule using the second casino scheduler to enter tournament detail for recurring daily and weekly tournament schedules. The second casino scheduler being the daily and weekly scheduler.

In another aspect of at least one embodiment of the present invention, the pre-specified criteria comprises one or more of a date, a buy-in (entry amount), a casino tournament name, a zip code, type of game, a location and a casino name.

In yet another aspect of at least one embodiment of the present invention, the method further includes sending marketing information to the least one player over a computer network, the marketing information being provided or requested by the at least one casino member.

In yet another aspect of at least one embodiment of the present invention, the marketing information is sent through one or more of email, banner add, a Short Messaging Service (SMS) message, a Multimedia Message (MMS), a voicemail and a phone call.

In yet another aspect of at least one embodiment of the present invention, the method further includes providing a first calendar for planning of schedule of the plurality of casino tournaments by, among other things, allowing the ability to view all their current, future, and past tournament schedules by the at least one casino member.

In yet another aspect of at least one embodiment of the present invention, the method further includes providing a second calendar for planning of schedule of the plurality of casino tournaments.

In yet another aspect of at least one embodiment of the present invention, the second calendar is a competition calendar, the competition calendar allowing the at least one casino member to view a schedule of at least one casino tournament of one or more other casino members, the one or more other casino members being selected from the one or more casino members.

In yet another aspect of at least one embodiment of the present invention, the method further includes providing a third calendar for planning of personal schedule by the at least one player.

In yet another aspect of at least one embodiment of the present invention, the method further includes tracking of one or more results in the selected one or more casino tournaments by the at least one player.

In yet another aspect of at least one embodiment of the present invention, the method further includes calculating payout of the at least one player.

In another embodiment of the present invention, a system for managing the scheduling of one or more casino tournaments, where a schedule is provided by one or more casino members to one or more players, the schedule being provided for participation in the one or more casino tournaments. The system comprises at least one server having an interface for communication over a computer network, a first login module, the first login module logging-in at least one casino member of the one or more casino members or at least one player of the one or more players, an upload module, the upload module uploading information of a plurality of casino tournaments, the information being provided by the at least one casino member through a scheduler module, a search module, the search module searching the plurality of casino tournaments based on a pre-specified criteria, the pre-specified criteria being provided by the at least one player, a selection module, the selection module selecting the one or more casino tournaments from the search results obtained from the search module, the casino tournaments being selected by the at least one player a scheduling/calendaring module, and the reservation module reserving at least one seat in the selected one or more casino tournaments for the at least one player.

In yet another aspect of at least one embodiment of the present invention, the system further includes a first casino scheduler, the special event scheduling module, providing a schedule for planning of the plurality of casino special tournaments by the at least one casino member.

In yet another aspect of at least one embodiment of the present invention, the system further includes a second casino scheduler, the daily and weekly event scheduling module, providing a schedule for planning of the plurality of casino daily and weekly tournaments by the at least one casino member.

In yet another aspect of at least one embodiment of the present invention, the system further includes a marketing module, the marketing module sending marketing information of the at least one of the plurality of casino tournaments to the one or more players, the marketing information being provided by the at least one casino member.

In yet another aspect of at least one embodiment of the present invention, the system further includes a first calendar module, the first calendar module used for planning of schedule of the plurality of casino tournaments by allowing the ability to view all their current, future, and past tournament schedules by the at least one casino member.

In yet another aspect of at least one embodiment of the present invention, the system further includes a second calendar module, the second calendar module providing a second calendar for planning of schedule of the plurality of casino tournaments by the at least one casino member.

In yet another aspect of at least one embodiment of the present invention, the second calendar module comprises a competition calendar module, the competition calendar module providing a competition calendar for allowing the at least one casino member to view a schedule of at least one casino tournament of one or more competing casino members, the one or more competing casino members being selected from the one or more casino members.

In yet another aspect of at least one embodiment of the present invention, the system further includes a third calendar module, the third calendar module providing a calendar for planning of personal schedule by the at least one player.

In yet another aspect of at least one embodiment of the present invention, the system further includes a tracker module, the tracker module tracking one or more results in the selected one or more casino tournaments by the at least one player.

In yet another aspect of at least one embodiment of the present invention, the system further includes a calculator module, the calculator module calculating payout of the at least one player.

In yet another embodiment of the present invention, a computer program product for use with a computer is provided. The computer usable medium has a computer readable program code embodied therein for managing the scheduling of one or more casino tournaments. A tournament schedule is provided by one or more casino members to one or more players, the schedule being provided for participation in the one or more casino tournaments. The computer program code logs-in at least one casino member of the one or more casino members or at least one player of the one or more players, uploads information of a plurality of casino tournaments, the information being provided by the at least one casino member through a scheduler module, searches the plurality of casino tournaments based on a pre-specified criteria, the pre-specified criteria being provided by the at least one player, selects the one or more casino tournaments from the search results obtained, the selection being requested by the at least one player and schedules/calendars at least one event in the selected one or more casino tournaments for the at least one player, sends marketing information of at least one of the plurality of casino tournaments to the one or more players, the marketing information being provided by the at least one casino member.

In yet another aspect of at least one embodiment of the present invention, the one or more casino members and the one or more players register at least once before providing the tournament schedules by the one or more casino members to the one or more players.

In yet another embodiment of the present invention, a method for managing schedules of one or more casino tournaments is provided. The method includes providing a website hosted by the at least one computer in communication with the computer network, logging-in at least one casino member of the one or more casino members, uploading information of a plurality of casino tournaments through the website, the information being provided by the at least casino member through a scheduler, logging-in at least one player of the one or more players through the website, searching the plurality of casino tournaments based on a pre-specified criteria, the pre-specified criteria being provided by the at least one player on the website, selecting the one or more casino tournaments from the search results obtained, the selection being requested by the at least one player, scheduling/calendaring at least one seat in the selected one or more casino tournaments for the at least one player through the website and sending marketing information of at least one of the plurality of casino tournaments to the one or more players, the marketing information being provided by the at least one casino member.

In yet another embodiment of the present invention, the method for managing schedules of the one or more casino tournaments includes logging-in at least one casino member of the one or more casino members. The method further includes uploading information of a plurality of casino tournaments, where the information is provided by the at least one casino member through a scheduler. Further, the method includes logging-in at least one player of the one or more players. Further, the method includes searching the plurality of casino tournaments based on a pre-specified criteria, where the pre-specified criteria is provided by the at least one player. Further, the method includes selecting the one or more casino tournaments from the search results obtained, where the selection is requested by the at least one player. Finally, the method includes scheduling at least one or more casino tournaments for the at least one player.

In yet another embodiment of the present invention, the system for managing schedules of the one or more casino tournaments includes at least one server having an interface for communication over a computer network. The system further includes a first login module, where the first login module logs in at least one casino member of the one or more casino members. Further, the system includes an upload module, where the upload module uploads information of a plurality of casino tournaments, where the information is provided by the at least one casino member through a scheduler. Further, the system includes a second login module, where the second login module logs in at least one player of the one or more players. Further, the system includes a search module, where the search module searches the plurality of casino tournaments based on a pre-specified criteria, where the pre-specified criteria is provided by the at least one player. Further, the system includes a selection module, where the selection module selects the one or more casino tournaments from the search results obtained, where the selection is requested by the at least one player. Finally, the system includes a scheduling module, where the scheduling module calendars at least one tournament for the at least one player.

In yet another embodiment, a method for providing and scheduling one or more casino tournaments over a computer network is provided. The method comprises, (1) providing one or more casino members with the ability to create an account or log-in to provide information regarding a plurality of casino tournaments over a computer network, (2) providing the one or more casino members with a log-in screen on one or more visual displays, (3) receiving information regarding the plurality of casino tournaments offered by a casino from the one or more casino members, the information being provided by the at least one casino member through a scheduler over a computer network, (4) providing one or more potential players in one or more casino games of the plurality of casino tournaments with the ability to search the plurality of casino tournaments offered by the one or more casino members based on pre-specified criteria of the plurality of casino tournaments over a computer network, the pre-specified criteria being selected by the one or more potential players, (5) providing the results of a search of the plurality of casino tournaments from a search requested by the one or more potential players on a visual display or computer readable medium, the results being provided based on the search requested by the one of more potential players selecting one or more pre-specified criteria regarding the plurality of casino tournaments and (6) providing the one or more potential players with the ability to schedule/calendar at least one or more casino tournaments provided in step (e).

In yet another aspect of the present invention, the information received from the one or more casino members includes at least the start and end date, type of game and amount of the buy-in for the plurality of casino tournaments;

In yet another aspect of the present invention, the one or more casino members create an account or register to provide casino tournament information over a computer network at least once before receiving information regarding the plurality of casino tournaments offered by the one or more casino members from the one or more casino members; and

In yet another aspect of the present invention, the pre-specified criteria comprises one or more of a keyword, a date, a, prize, a celebrity, a month or date, a casino tournament name, a casino, a zip code, type of casino game, buy-in options, number of players, format of one or more casino games offered, buy-in amount, a number of players at each game, type of game, a location and a casino name.

In yet another embodiment of the present invention, a system for scheduling and providing schedules for one or more casino tournaments is provided. The system comprises (1) at least one server having an interface for communication over a computer network, (2) a first login module, the first login module logging-in at least one casino member of the one or more casino members or at least one potential player of the one or more potential players, (3) an upload module, the upload module uploading information regarding one or more casino tournaments, the information being provided by the at least one casino member through a scheduler, (4) a search module, the search module searching the plurality of casino tournaments based on a pre-specified criteria, the pre-specified criteria being provided by the at least one potential player, (5) a selection module, the selection module selecting the one or more casino tournaments from the search results obtained from the search module, the casino tournaments being selected by the at least one potential player and In yet another aspect of the present invention, a computer program product for use with a computer is provided. The computer program product comprises (1) a computer usable medium having computer readable program code embodied therein for scheduling of one or more casino tournaments, where a schedule is provided by one or more casino members to one or more players, the scheduling being provided for participation in the one or more casino tournaments, the computer program code performing, (2) logging-in at least one casino member of the one or more casino members or at least one player of the one or more players (3) uploading information of a plurality of casino tournaments, the information being provided by the at least one casino member, (4) searching the plurality of casino tournaments based on a pre-specified criteria, the pre-specified criteria being provided by the at least one player (5) selecting the one or more casino tournaments from the search results obtained, the selection being requested by the at least one player, (6) scheduling/calendaring at least one event in the selected one or more casino tournaments for the at least one player and (7) sending marketing information of at least one of the plurality of casino tournaments to the one or more players, the marketing information being provided by the at least one casino member;

In yet another aspect of the present invention, a method for providing and scheduling reservations of one or more casino tournaments, is provided. The method comprises, (1) providing a website hosted by the at least one computer in communication with the computer network, (2) logging-in at least one casino member of the one or more casino members, (3) uploading information of a plurality of casino tournaments through the website, the information being provided by the at least casino member through a scheduler, (4) logging-in at least one player of the one or more players through the website, (5) searching the plurality of casino tournaments based on a pre-specified criteria, the pre-specified criteria being provided by the at least one player on the website, (6) selecting the one or more casino tournaments from the search results obtained, the selection being requested by the at least one player, (7) scheduling/calendaring at least one event in the selected one or more casino tournaments for the at least one player through the website and sending marketing information of at least one of the plurality of casino tournaments to the one or more players, the marketing information being provided by the at least one casino member.

### BRIEF DESCRIPTION OF THE DRAWING

The above, and other embodiments of the present invention, may be more fully understood from the following detailed description taken together with the accompanying drawing wherein similar reference characters refer to similar elements and in which:

FIG. 1 illustrates an environment in which the various embodiments of the invention can be practiced.

FIG. 2 shows a flowchart for managing scheduling of one or more casino tournaments, in accordance with an embodiment of the present invention.

FIG. 3 shows a flowchart for managing scheduling of one or more casino tournaments, in accordance with another embodiment of the present invention.

FIG. 4 illustrates a system for managing scheduling of one or more casino tournaments, in accordance with an embodiment of the present invention.

FIG. 5 illustrates a system for managing scheduling of one or more casino tournaments, in accordance with another embodiment of the present invention.

FIG. 6 illustrates a casino home page of a casino member, in accordance with an embodiment of the present invention.

FIG. 7 illustrates a view of the competition calendar of the casino member, in accordance with an embodiment of the present invention.

FIG. 8 illustrates a casino monster view page of the casino member, in accordance with an embodiment of the present invention.

FIG. 9 illustrates a daily and weekly event scheduler for the casino member, in accordance with an embodiment of the present invention.

FIG. 10 illustrates a special event scheduler for the casino member, in accordance with an embodiment of the present invention

FIG. 11 illustrates an ‘Add/Edit structure’ form for the casino member, in accordance with an embodiment of the present invention.

FIG. 12 illustrates a registration tracker page for the casino member, in accordance with an embodiment of the present invention.

FIG. 13 illustrates a webpage of a chop-chop calculator for the casino member, in accordance with an embodiment of the present invention.

FIG. 14 illustrates a view of casino detail page for the casino member, in accordance with an embodiment of the present invention.

FIG. 15 illustrates a view of a special event page for the casino member according to an embodiment of the present invention.

FIG. 16 illustrates a view of a game page for the casino member, in accordance with an embodiment of the present invention.

FIG. 17 illustrates a view of a casino ‘e-mail blasts’ page for the casino member, in accordance with an embodiment of the present invention.

FIG. 18 illustrates a casino profile home page for the casino member, in accordance with an embodiment of the present invention.

FIG. 19 illustrates a ‘modify business information’ webpage for the casino member, in accordance with an embodiment of the present invention.

FIG. 20 illustrates a ‘modify visible information webpage’ for the casino member, in accordance with an embodiment of the present invention.

FIG. 21 illustrates a change competition webpage for the casino member, in accordance with an embodiment of the present invention.

FIG. 22 illustrates a player home page for the player, in accordance with an embodiment of the present invention.

FIG. 23 illustrates a player monster view page of the player, in accordance with an embodiment of the present invention.

FIG. 24 illustrates a poker room webpage of the player, in accordance with an embodiment of the present invention.

FIG. 25 illustrates a view of a ‘my e-mail blasts’ page for the player, in accordance with an embodiment of the present invention.

FIG. 26 illustrates a bankroll page for the player, in accordance with an embodiment of the present invention.

FIG. 27 illustrates a ‘player notes webpage’ for the player, in accordance with an embodiment of the present invention.

FIG. 28-30 illustrates user profile pages for the player, in accordance with an embodiment of the present invention.

FIG. 31 illustrates a ‘My Cart’ webpage for the player, in accordance with an embodiment of the present invention.

FIG. 32 shows a membership payment page for the player, in accordance with an embodiment of the present invention.

FIG. 33 shows a registration confirmation webpage for the player, in accordance with an embodiment of the present invention.

FIG. 34 shows a help webpage, in accordance with an embodiment of the present invention.

### DESCRIPTION OF THE PREFERRED EMBODIMENTS

Before describing in detail the particular method and system for managing scheduling and marketing of casino tournaments of a user in accordance with an embodiment of the present invention, it should be observed that the present invention resides primarily in combinations of method steps and system components related to managing scheduling and marketing of casino tournaments.

Accordingly, the method steps and system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

The present invention provides, among other things, methods, systems and apparatus for managing schedules and marketing of casino tournaments. More specifically, in at least one embodiment, the present invention provides methods, system and apparatus for managing schedules of one or more casino tournaments through registration of one or more casinos and one or more players. The one or more casinos upload information of plurality of tournaments. Subsequently, at least one player of the one or more players search the plurality of tournament based on a pre-specified criteria. Thereafter, the at least one player selects a tournament based on the pre-specified criteria and an event is scheduled/calendared for the at least one player in the selected tournament.

In another embodiment of the present invention, a method for managing schedules of one or more casino tournaments over a computer network is provided. The method comprises providing at least one casino member of the one or more casino members the ability to create an account or register to provide casino tournament information over a computer network, providing at least one casino member of the one or more casino members with a log-in screen on one or more visual displays, receiving information regarding a plurality of casino tournaments offered by the one or more casino members from the one or more casino members, providing a scheduler where the information being provided by the at least one casino member over a computer network, providing the at least one player of the one or more players the ability to search the plurality of casino tournaments offered by the one or more casino members based on a pre-specified criteria over a computer network through a scheduler, the pre-specified criteria being selected by the at least one player, providing the results of a search of the one or more casino tournaments from the search requested from the at least one or more players on a visual display or computer readable medium, the results being provided based on the search requested by the one or more pre-specified criteria selected by the at least one or more players and providing the at least one or more player with the ability to schedule/calendar at least one event in one or more casino tournaments provided in the requested search.

In an aspect of at least one embodiment of the present invention, the one or more casino members create an account or register to provide casino tournament information over a computer network at least once before receiving information regarding a plurality of casino tournaments offered by the one or more casino members from the one or more casino members and the schedule is provided for the at least one or more players to participate in the one or more casino tournaments offered by the one or more casino members.

In another aspect of at least one embodiment of the present invention, the pre-specified criteria comprises one or more of a keyword, a date, a, prize, a celebrity, a month, a casino tournament name, a zip code, type of game, a location and a casino name.

In yet another aspect of at least one embodiment of the present invention, the method further includes receiving payment information over a computer network from the at least one player for the at least one player's participation in the selected one or more casino tournaments, the payment information being provided by the at least one player.

In yet another aspect of at least one embodiment of the present invention, the method further includes receiving processing the payment information through one or more payment means, the one or more payment means being a credit card, a debit card, a direct debit or other electronic transfer of funds.

In yet another aspect of at least one embodiment of the present invention, the method further includes sending marketing information to the least one player over a computer network, the marketing information being provided or requested by the at least one casino member.

In yet another aspect of at least one embodiment of the present invention, the marketing information is sent through one or more of an email, a banner add, a Short Messaging Service (SMS) message, a Multimedia Message (MMS), a voicemail and a phone call.

In yet another aspect of at least one embodiment of the present invention, the method further includes the ability to provide scheduling information for special events for planning of schedules of the plurality of casino tournaments by the at least one casino member.

In yet another aspect of at least one embodiment of the present invention, the method further includes the ability to provide scheduling information for daily and weekly events for planning of schedules of the plurality of casino tournaments by the at least one casino member.

In yet another aspect of at least one embodiment of the present invention, the method further includes providing a first calendar for planning by allowing the ability to view all their current, future, and past tournament schedules by the at least one casino member.

In yet another aspect of at least one embodiment of the present invention, the method further includes providing a second calendar for planning of schedule of the plurality of casino tournaments by the at least one casino member.

In yet another aspect of at least one embodiment of the present invention, the second calendar is a competition calendar, the competition calendar allowing the at least one casino member to view a schedule of at least one casino tournament of one or more other casino members, the one or more other casino members being selected from the one or more casino members.

In yet another aspect of at least one embodiment of the present invention, the method further includes providing a third calendar for planning of personal schedule by the at least one player.

In yet another aspect of at least one embodiment of the present invention, the method further includes tracking of one or more results in the selected one or more casino tournaments by the at least one player.

In yet another aspect of at least one embodiment of the present invention, the method further includes calculating payout of the at least one player.

In yet another embodiment of the present invention, a system for managing schedules of one or more casino tournaments, where a scheduled/calendared event is provided by one or more casino members to one or more players, the scheduled/calendared event being provided for participation in the one or more casino tournaments is provided. The system comprises at least one server having an interface for communication over a computer network, a first login module, the first login module logging-in at least one casino member of the one or more casino members or at least one player of the one or more players, an upload module, the upload module uploading information of a plurality of casino tournaments, the information being provided by the at least one casino member through a scheduler, a search module, the search module searching the plurality of casino tournaments based on a pre-specified criteria, the pre-specified criteria being provided by the at least one player, a selection module, the selection module selecting the one or more casino tournaments from the search results obtained from the search module, the casino tournaments being selected by the at least one player, a scheduling/calendaring module, and the reservation module reserving at least one seat in the selected one or more casino tournaments for the at least one player.

In yet another aspect of at least one embodiment of the present invention, the system further includes a marketing module, the marketing module sending marketing information of the at least one of the plurality of casino tournaments to the one or more players, the marketing information being provided by the at least one casino member.

In yet another aspect of at least one embodiment of the present invention, the reservation module comprises a payment module, the payment module accepting payment for participation in the selected one or more casino tournaments, the payment being provided by the at least one player.

In yet another aspect of at least one embodiment of the present invention, the method further includes providing a first calendar for planning by allowing the ability to view all their current, future, and past tournament schedules by the at least one casino member.

In yet another aspect of at least one embodiment of the present invention, the system further includes a second calendar module, the second calendar module providing a competition calendar for planning of schedule of the plurality of casino tournaments by the at least one casino member.

In yet another aspect of at least one embodiment of the present invention, the second calendar module comprises a competition calendar module, the competition calendar module providing a competition calendar for allowing the at least one casino member to view a schedule of at least one casino tournament of one or more competing casino members, the one or more competing casino members being selected from the one or more casino members.

In yet another aspect of at least one embodiment of the present invention, the system further includes a third calendar module, the third calendar module providing a calendar for planning of personal schedule by the at least one player.

In yet another aspect of at least one embodiment of the present invention, the system further includes a tracker module, the tracker module tracking one or more results in the selected one or more casino tournaments by the at least one player.

In yet another aspect of at least one embodiment of the present invention, the system further includes a calculator module, the calculator module calculating payout of the at least one player.

In yet another embodiment of the present invention, a computer program product for use with a computer is provided. The computer usable medium has a computer readable program code embodied therein for managing schedules of one or more casino tournaments. A schedule is provided by one or more casino members to one or more players, the schedule being provided for participation in the one or more casino tournaments. The computer program code logs-in at least one casino member of the one or more casino members or at least one player of the one or more players, uploads information of a plurality of casino tournaments, the information being provided by the at least one casino member through a scheduler, searches the plurality of casino tournaments based on a pre-specified criteria, the pre-specified criteria being provided by the at least one player, selects the one or more casino tournaments from the search results obtained, the selection being requested by the at least one player and schedules/calendars at least one event in the selected one or more casino tournaments for the at least one player, sends marketing information of at least one of the plurality of casino tournaments to the one or more players, the marketing information being provided by the at least one casino member.

In yet another aspect of at least one embodiment of the present invention, the one or more casino members and the one or more players register at least once before providing the scheduling by the one or more casino members to the one or more players.

In yet another embodiment of the present invention, a method for managing schedules of one or more casino tournaments is provided. The method includes providing a website hosted by the at least one computer in communication with the computer network, logging-in at least one casino member of the one or more casino members, uploading information of a plurality of casino tournaments through the website, the information being provided by the at least casino member through a scheduler, logging-in at least one player of the one or more players through the website, searching the plurality of casino tournaments based on a pre-specified criteria, the pre-specified criteria being provided by the at least one player on the website, selecting the one or more casino tournaments from the search results obtained, the selection being requested by the at least one player, scheduling/calendaring at least one event in the selected one or more casino tournaments for the at least one player through the website and sending marketing information of at least one of the plurality of casino tournaments to the one or more players, the marketing information being provided by the at least one casino member.

In yet another aspect of the present invention, the method includes the casino member, which can be any party that handles the task of providing casino tournament information on behalf of the casino, providing specific information regarding the game or games that are part of the tournament. For example and not by way of limitation, if the tournament is a poker tournament, the casino member would provide any combination of beginning and ending date and time, event name, event number, type of game, format of the game, buy-in amount and options and number of plays for one or more games in a casino tournament. Additionally, the casino member has the ability to activate or deactivate the tournament schedule, inside the scheduler, whether certain tournaments or games within certain tournaments are active and therefore available for viewing to potential players of the tournaments.

It should be appreciated that the present invention provides, among other things, a quick and simple way for a casinos to enter information about casino tournaments and communicate this information to their intended audience, potential players through a scheduler.

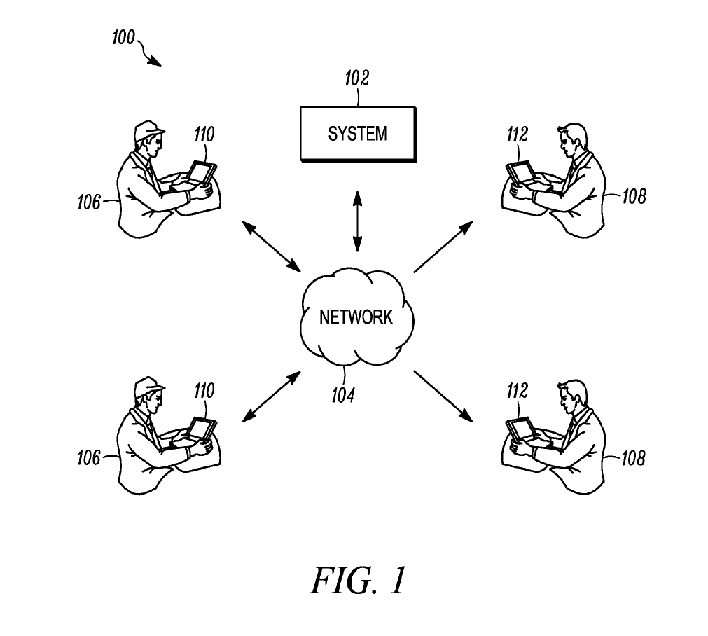

FIG. 1 illustrates an environment 100 in which the various embodiments of the invention can be practiced. Environment 100 shows a system 102, a network 104, and one or more casino members such as a casino member 106. Further, the figure shows one or more players such as a player 108, one or more computing devices for players such as a computing device 110 and one or more computing devices for casino members such as a computing device 112. In various embodiment of the present invention, the system 102 is hosted on a server. The server can be one or more of a dedicated hosting server and shared hosting server. The system 102 is connected to the one or more computing devices through the network 104. Examples of the network 104 include, but are not limited to, internet, intranet, WiFi, Bluetooth, Infrared, WiMAX, Local Area Network (LAN), GPRS, EDGE, and Virtual Private network (VPN).

According to one of the embodiments of the present invention, the network 104 is a conglomeration of connected intranets.

According to another embodiment of the present invention, the network 104 is IPV6 compatible internet.

The system 102 provides a user-interface for the player 108, which is accessed through the computing device 112, for requesting one or more operations, where the one or more operations are performed by the system 102. The system 102 further provides a user-interface for the casino member 106, which is accessed through the computing device 110, for requesting the one or more operations. The one or more operations can be requested by at least one of the casino member 106 and the player 108. Examples of the one or more computing devices include, but are not limited to, a computer, a laptop, a PDA, a mobile phone, and an interactive kiosk. Examples of the user-interface include, but are not limited to, a webpage on a website. Examples of the one or more operations include, but are not limited to, an input operation, a search operation, an upload operation, and a select operation.

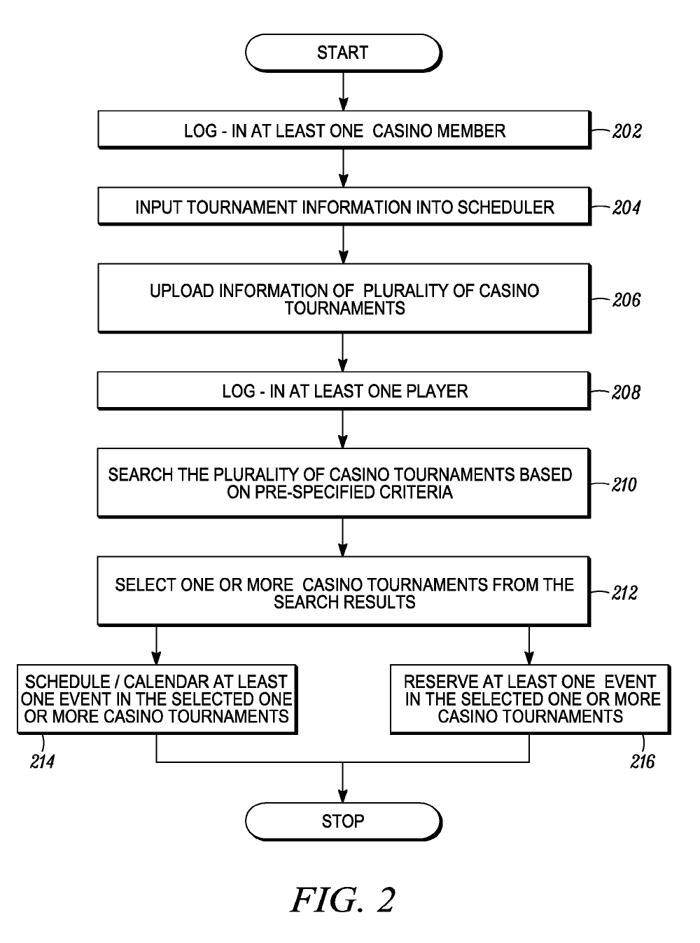

FIG. 2 shows a flowchart for managing schedules of one or more casino tournaments, in accordance with an embodiment of the present invention. Examples of the one or more casino tournaments include, but are not limited to, poker, blackjack, baccarat, roulette, slot machines and craps. At Step 202, the system 102 logs-in the casino-member 106 by accepting a casino username and casino password through the user-interface. The casino username and the casino password are created during registration of the casino member 106.

According to an embodiment of the present invention, the system 102 registers the casino member 106 at least once before logging-in the casino member 106 to perform the one or more operations. The registration of the casino member 106 is performed by accepting first registration information. The casino member 106 provides the first registration information through the user-interface provided by the computing device 110.

According to an embodiment of the present invention, the first registration information includes one or more of a casino name, password, phone number, address, personal preferences and the like.

At Step 204, information is input into one of two schedulers. The information is provided by the casino member 106 through the use-interface provided by the computing device 110.

At Step 206, information of a plurality of casino tournaments is uploaded on the system 102. The information of the plurality of casino tournaments is provided by the casino member 106 through the user-interface provided by the computing device 110.

According to an embodiment of the present invention, the information of the plurality of tournaments include, but are not limited to, a tournament name, date, venue, guaranteed prize pool.

At Step 208, the system 102 logs-in the player 108 by accepting a player name and a player password through the user-interface. The player username and the player password are created during registration of the player 108.

According to an embodiment of the present invention, the system 102 registers the player 108 at least once before logging-in of the player 108 to perform the one or more operations. The registration of the player 108 is performed by accepting a second registration information. The player 108 provides the second registration information through the user-interface provided by the computing device 112.

According to another embodiment of the present invention, the second registration information includes one or more of a player name, password, date of birth, gender, personal preferences and the like.

At Step 210, the system 102 searches the plurality of casino tournaments based on a pre-specified criteria. The pre-specified criteria is provided by the player 108 through the user-interface provided by the computing device 112 and includes one or more of a keyword, a date, a month, a casino tournament name, a zip code, a location and a casino name. At step 212, the one or more casino tournaments are selected from the search results obtained at the step 210. The selection of the one or more casino tournaments is requested by the player 108 through the user-interface. At Step 214, the system 102 schedules/calendars at least one event in the selected one or more casino tournaments for the player 108. Step 216, the system 102 reserves at least one event in the selected one ore more casino tournaments for the player 108.

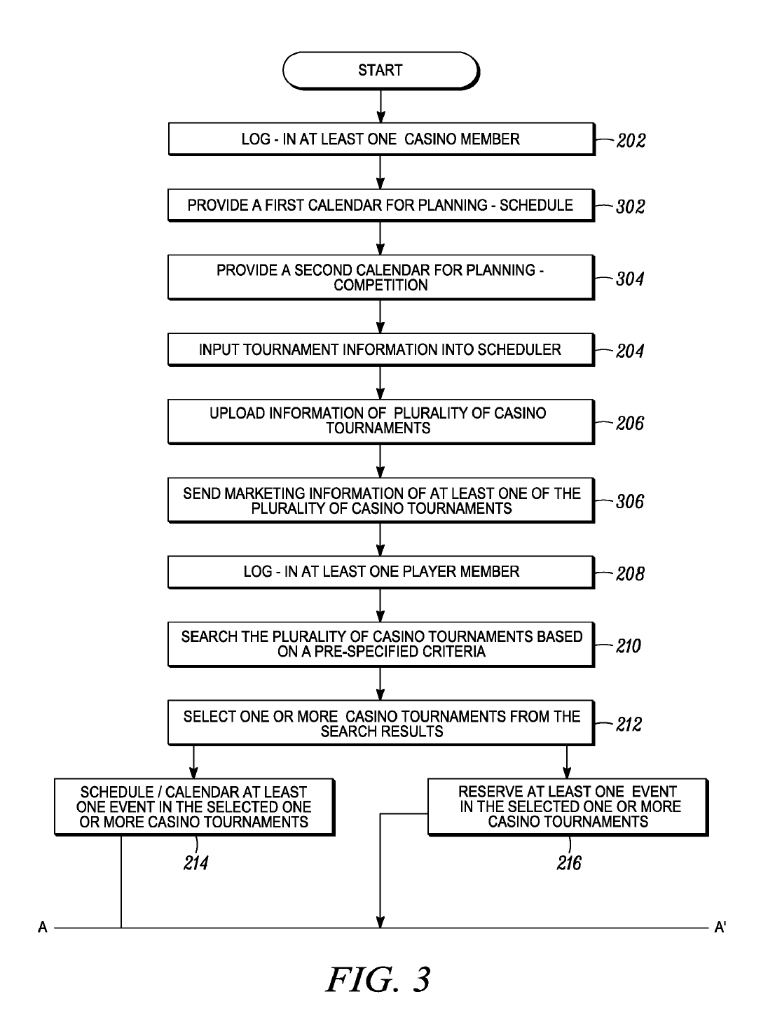

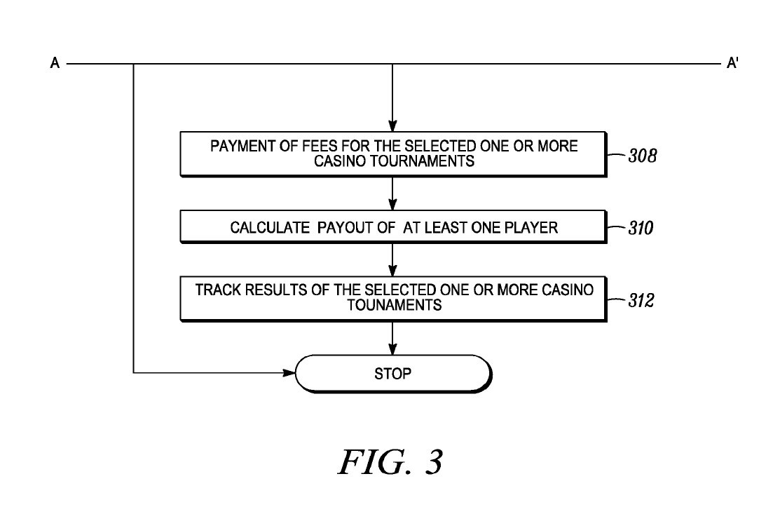

FIG. 3 shows a flowchart for managing schedules of one or more casino tournaments, in accordance with another embodiment of the present invention. At Step 202, the system 102 logs-in the casino member 106 by accepting the casino username and the casino password through the user-interface provided by the computing device 110. The casino username and the casino password are created during the registration of the casino member 106.

At Step 302, the system 102 provides a first calendar for planning a schedule of the plurality of tournaments. The planning of the plurality of tournaments is performed by the casino member 106. The casino member 106 accesses the first calendar through the user-interface provided by the computing device 110.

According to an embodiment of the present invention, the first calendar is for the planning of schedule of the plurality of casino tournaments by allowing the ability to view all their current, future, and past tournament schedules by the at least one casino member

At Step 304, the system 102 provides a second calendar, a competition calendar, for the scheduling of the plurality of tournaments. The planning of the plurality of tournaments is performed by the casino member 106. The casino member 106 accesses the second calendar through the user-interface provided by the computing device 110.

According to an embodiment of the present invention, the second calendar is a competition calendar. The competition calendar allows the casino member 106 to view a schedule of one or more casino tournaments of one or more competing casinos. The one or more competing casinos are selected from the one or more casino members. In an embodiment of the present invention, the casino member 106 schedules a casino tournament such that the date of the tournament does not conflict with the dates of tournaments of the one or more competing casino members.

At Step 204, the system 102 provides a first scheduling module for entering of data of special events to schedule the plurality of tournaments. The scheduling of special events is performed by the casino member 106. The casino member 106 accesses the first scheduling module through the user-interface provided by the computing device 110.

According to an embodiment of the present invention, the special events schedule module creates a schedule for special casino tournaments. The special events module allows the casino member 106 to create a special events schedule of one or more casino tournaments. The special events schedule is created by one or more casino members. In an embodiment of the present invention, the casino member 106 schedules a casino tournament such that the date of the tournament, by utilizing the second calendar, the competition calendar, to assure the special event does not conflict with the dates of tournaments of the one or more competing casino members.

At Step 204, the system 102 also provides a second scheduling module for entering of data of daily and weekly events to schedule the plurality of tournaments. The scheduling of daily and weekly events is performed by the casino member 106. The casino member 106 accesses the second scheduling module through the user-interface provided by the computing device 110.

According to an embodiment of the present invention, the daily and weekly events schedule module creates a schedule for daily and weekly casino tournaments. The daily and weekly events scheduler module allows the casino member 106 to create a daily or weekly schedule of one or more casino tournaments. The daily and weekly events schedule is created by one or more casino members. In an embodiment of the present invention, the casino member 106 schedules a daily or weekly casino tournament such that the date of the tournament by utilizing the second calendar, the competition calendar, to assure the daily or weekly event does not overlap with the dates of tournaments of the one or more competing casino members.

At Step 206, information of a plurality of casino tournaments is uploaded on the system 102. The information of the plurality of casino tournaments is provided by the casino member 106 through the user-interface provided by the computing device 110.

According to an embodiment of the present invention, the information of the plurality of tournaments include, but are not limited to, a tournament name, date, venue, guaranteed prize pool.

In an embodiment of the present invention, the system 102 uploads the information into a database, where the database is hosted on the server on which the system 102 is hosted.

At Step 306, the system 102 sends marketing information of at least one casino tournament of the plurality of casino tournaments to the player 108. The selection of the at least one casino tournament for sending the marketing information is provided by the casino member 106.

According to an embodiment of the invention, the marketing information is sent through one or more of an email, a Short Messaging Service (SMS) message, a Multimedia Message (MMS) and a phone call. Examples of the marketing information include, but are limited to, information about new casino tournaments, information about upcoming casino tournaments, information about a special offer for new players who register for a first time for a tournament, and information about discount offers for registering for a tournament.

At Step 208, the system 102 logs-in the player 108 by accepting a player name and player password through the user-interface provided by the computing device 112. The player username and the player password are created during registration of the player 108.

At Step 210, the system 102 searches the plurality of casino tournaments based on the pre-specified criteria. The pre-specified criterion is provided by the user through the user-interface. The pre-specified criteria includes one or more of a keyword, a date, a month, a casino tournament name, a zip code, a location and a casino name. At step 212, the one or more casino tournaments are selected from the search results obtained at the step 210. The selection of the one or more casino tournaments is requested by the player 108 through the user-interface provided by the computing device 112.

At Step 214, the at least one event is scheduled and calendared in the selected one or more casino tournaments for the player 108 by the system 102.

At Step 216, the at least one event is reserved in the selected one or more casino tournaments for the player 108 by the system 102.

At step 308, the system 102 accepts a payment for the reservation of at least one seat in the selected one or more casino tournaments through the user-interface provided by the computing device 112. The payment is provided by the player 108 for reserving the at least one seat, where the payment is provided through one or more of payment means. The one or more payment means are selected from one of a credit card, a debit card, a direct debit, a bank cheque and cash.

At step 310, the system 102 tracks one or more results of the one or more casino tournaments. The tracking of one or more results is requested by the player 108 through the user-interface provided by the computing device 112. In the present embodiment, system 102 tracks the result of the selected one or more casino tournaments.

At Step 312, the system 102 calculates payout for the player 108 for the selected one or more casino tournaments.

According to an embodiment of the present invention, the system 102 provides a third calendar. The third calendar is used by the player 108 for planning of personal schedule. The player 108 can use the third calendar for organizing his schedule for the selected one or more casino tournaments. The third calendar is capable of sending alerts to the player 108 when a date of the selected one or more tournaments approaches.

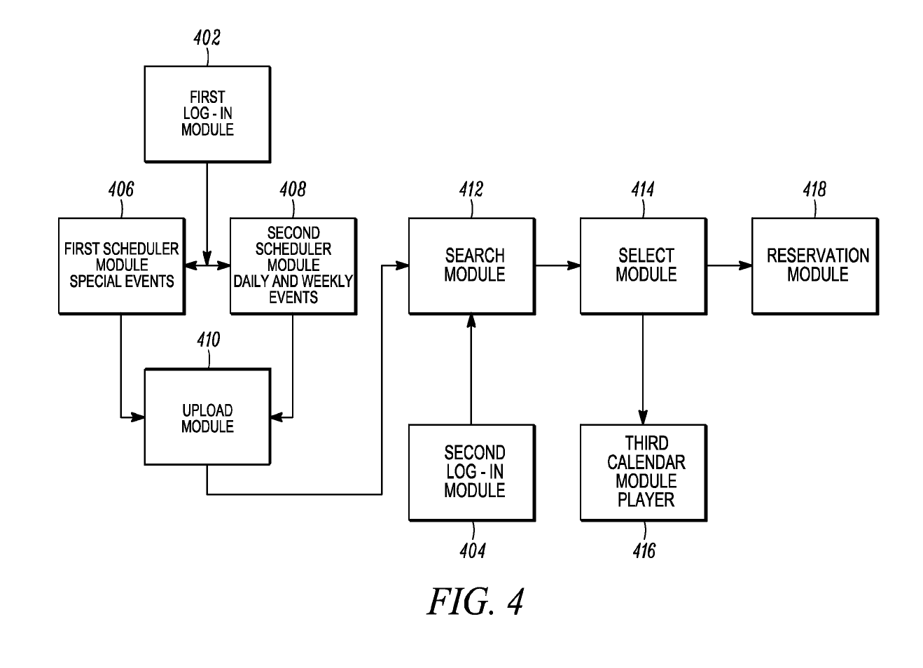

FIG. 4 illustrates the system 102 for managing the schedules of one or more casino tournaments, in accordance with an embodiment of the present invention. The system 102 includes a first log-in module 402, a second log-in module 404, a first scheduler module for special events 406, a second scheduler module for daily and weekly events 408, an upload module 410, a search module 412, a select module 414, a third calendar for player module 416, and a reservation module 418. The first log-in module 402 logs-in the casino-member 106 by accepting the casino username and the casino password through the user-interface provided by the computing device 110. The casino username and the casino password are created during registration of the casino member 106.

According to an embodiment of the present invention, the system 102 registers the casino member 106 at least once before logging-in of the casino member 106 to perform the one or more operations.

The second log-in module 404 logs-in the player 108 by accepting the player name and the player password through the user-interface provided by the computing device 112. The player username and the player password are created during registration of the player 108.

According to an embodiment of the present invention, the system 102 registers the player 108 at least once before logging-in of the player 108 to perform the one or more operations

The first scheduler module 406 creates special events schedules for the plurality of casino tournaments. The information of the plurality of casino tournaments is provided by the casino member 106 through the user-interface provided by the computing device 110.

The second scheduler module 408 creates daily and weekly events schedules for the plurality of casino tournaments. The information of the plurality of casino tournaments is provided by the casino member 106 through the user-interface provided by the computing device 110.

The upload module 410 uploads the information of the plurality of casino tournaments. The information of the plurality of casino tournaments is provided by the casino member 106 through the user-interface scheduler modules provided by the computing device 110.

According to an embodiment of the present invention, the information of the plurality of casino tournaments include, but are not limited to, a tournament name, date, venue, guaranteed prize pool and the like.

The search module 412 searches the plurality of casino tournaments based on a pre-specified criteria. The pre-specified criteria is provided by the user through the user-interface and includes one or more of a keyword, a date, a month, a casino tournament name, a zip code, a location and a casino name. Subsequently, the select module 414 selects a one or more casino tournaments from the search results provided by the search module 412. The selection of the one or more casino tournament is requested by the player 108 through the user-interface provided by the computing device 112. The third player calendar module 416 allows the player to schedule/calendar the one or more selected casino tournaments from the search results provided by the search module 412. Thereafter, the reservation module 418 reserves at least one seat for the selected one or more casino tournaments for the player 108.

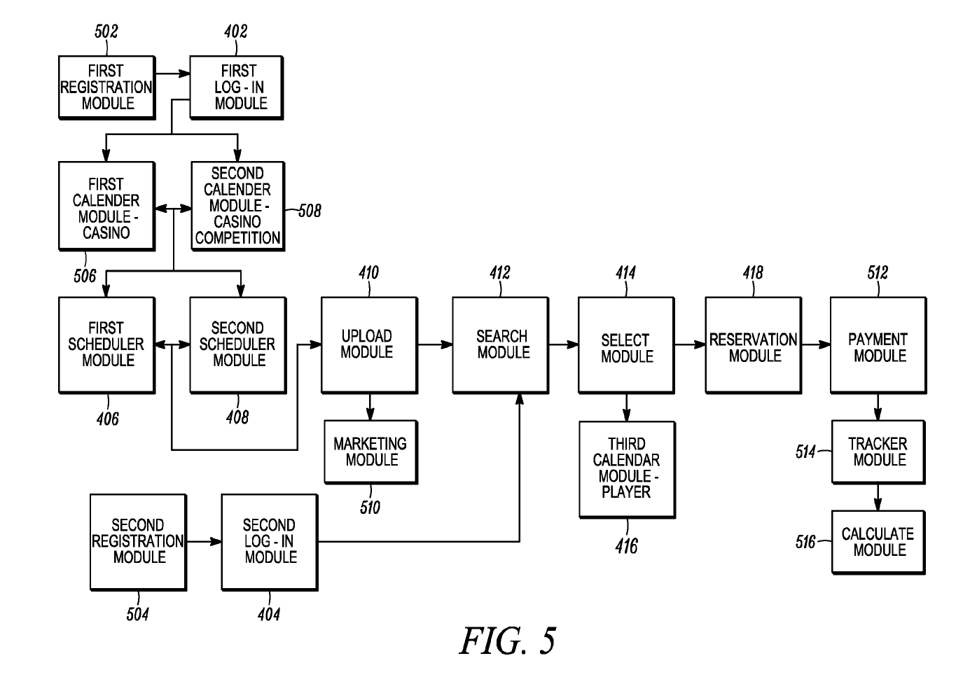

FIG. 5 illustrates a system 102 for managing schedules of one or more casino tournaments, in accordance with another embodiment of the present invention. The system 102 includes a first registration module 502, a second registration module 504, a first casino calendar module 506, a second competition calendar module 508, a marketing module 510, a payment module 512, a tracker module 514, a calculator module 516, the first log-in module 402, the second log-in module 404, the first special event scheduler module 406, the second daily and weekly event scheduler 408, the upload module 410, the search module 412, the select module 414, the third player calendar module 416, and the reservation module 418. The first registration module 502 registers the casino member 106 by accepting the first registration information. The casino member 106 provides the first registration information through the user-interface provided by the computing device 110.

According to an embodiment of the present invention, the first registration information includes providing one or more of a casino name, a password, a phone number, address, and personal preferences.

The second registration module 504 registers the player 108 by accepting the second registration information. The player 108 provides the second registration information through the user-interface provided by the computing device 112.

According to another embodiment of the present invention, the second registration information includes providing one or more of a player name, date of birth, gender, password, personal preferences and the like.

The first log-in module 402 logs-in the casino-member 106 by accepting the casino username and the casino password through the user-interface. The casino username and the casino password are created during the registration of the casino member 106 by the first registration module 502.

The second log-in module 404 logs-in the player 108 by accepting the player name and the player password through the user-interface provided by the computing device 112. The player username and the player password are created during the registration of the player 108 by the second registration module 504.

The first casino calendar module 506 facilitates planning of schedule of the plurality of casino tournaments by providing past, current and future casino tournament schedules. The casino member 106 accesses the first calendar module through the user-interface provided by the computing device 110.

According to an embodiment of the present invention, the first casino calendar is for the planning of schedule of the plurality of casino tournaments by allowing the ability to view all their current, future, and past tournament schedules by the at least one casino member

The second calendar module 508, a competition calendar, for the scheduling of the plurality of tournaments. The planning of the plurality of tournaments is performed by the casino member 106. The casino member 106 accesses the second calendar through the user-interface provided by the computing device 110.

According to an embodiment of the present invention, the second calendar is a competition calendar. The competition calendar allows the casino member 106 to view a schedule of one or more casino tournaments of one or more competing casinos. The one or more competing casinos are selected from the one or more casino members. In an embodiment of the present invention, the casino member 106 schedules a casino tournament such that the date of the tournament does not conflict with the dates of tournaments of the one or more competing casino members.

The first scheduling module 406 is for entering of data of special events to schedule the plurality of tournaments. The scheduling of special events is performed by the casino member 106. The casino member 106 accesses the first scheduling module through the user-interface provided by the computing device 110.

According to an embodiment of the present invention, the special events schedule module creates a schedule for special casino tournaments. The special events module allows the casino member 106 to create a special events schedule of one or more casino tournaments. The special events schedule is created by one or more casino members. In an embodiment of the present invention, the casino member 106 schedules a casino tournament such that the date of the tournament, by utilizing the second calendar, the competition calendar, to assure the special event does not conflict with the dates of tournaments of the one or more competing casino members.

The second scheduling module 508 used for entering of data of daily and weekly events to schedule the plurality of tournaments. The scheduling of daily and weekly events is performed by the casino member 106. The casino member 106 accesses the second scheduling module through the user-interface provided by the computing device 110.

According to an embodiment of the present invention, the daily and weekly events schedule module creates a schedule for daily and weekly casino tournaments. The daily and weekly events scheduler module allows the casino member 106 to create a daily or weekly schedule of one or more casino tournaments. The daily and weekly events schedule is created by one or more casino members. In an embodiment of the present invention, the casino member 106 schedules a daily or weekly casino tournament such that the date of the tournament by utilizing the second calendar, the competition calendar, to assure the daily or weekly event does not overlap with the dates of tournaments of the one or more competing casino members.

The upload module 410 uploads the information of the plurality of casino tournaments. The information of the plurality of casino tournaments is provided by the casino member 106 through the user-interface provided by the computing device 110.

According to an embodiment of the invention, the upload module 410 uploads the information entered by the casino member 106 through the user interface including, but not limited to the special events scheduler and the daily and weekly events schedulers. Examples of the uploaded tournament information include, but are not limited to, tournament name, individual event name, date, time, entry fee, type of game, guarantee amount and general comments about the events.

The marketing module 510 sends marketing information of at least one casino tournament of the plurality of casino tournaments to the player 108. The selection of the at least one casino tournament for sending of the marketing information is performed by the casino member 106.

According to an embodiment of the invention, the marketing information is sent through one or more of an email, a Short Messaging Service (SMS) message, a Multimedia Message (MMS) and a phone call. Examples of the marketing information include, but are not limited to, information about new casino tournaments, information about upcoming casino tournaments, information about a special offer for new players who register for a first time for a tournament, and information about discount offers for registering for a tournament.

The search module 412 searches the plurality of casino tournaments based on the pre-specified criteria. Subsequently, the select module 414 selects one or more casino tournaments from the search results provided by the search module 412. The selection of a tournament is requested by the player 108 through the user-interface provided by the computing device 110. The third player calendaring module 416 allows the player to schedule/calendar the selection of tournaments from the search results provided by the select module 414. The payment module 512 accepts a payment for the reservation of at least one seat in the selected one or more casino tournaments through the user-interface provided by the computing device 110. The payment is provided by the player 108 through one or more of payment means. The one or more payment means are selected from one of a credit card, a debit card, a direct debit, a bank cheque and cash. Thereafter, the reservation module 418 reserves the at least one seat for the selected one or more casino tournaments for the player 108.

The tracker module 514 is capable of tracking one or more results of the one or more casino tournaments. The tracking of one or more results is requested by the player 108 through the user-interface provided by the computing device 112. In the present embodiment, player 108 tracks the result of the selected one or more casino tournaments. The calculator module 516 is capable of calculating payout of the at least one players for the selected one or more casino tournaments.

According to an embodiment of the present invention, the system 102 includes a third calendar module. The third calendar module provides a third calendar for planning of a personal schedule by the player 108.

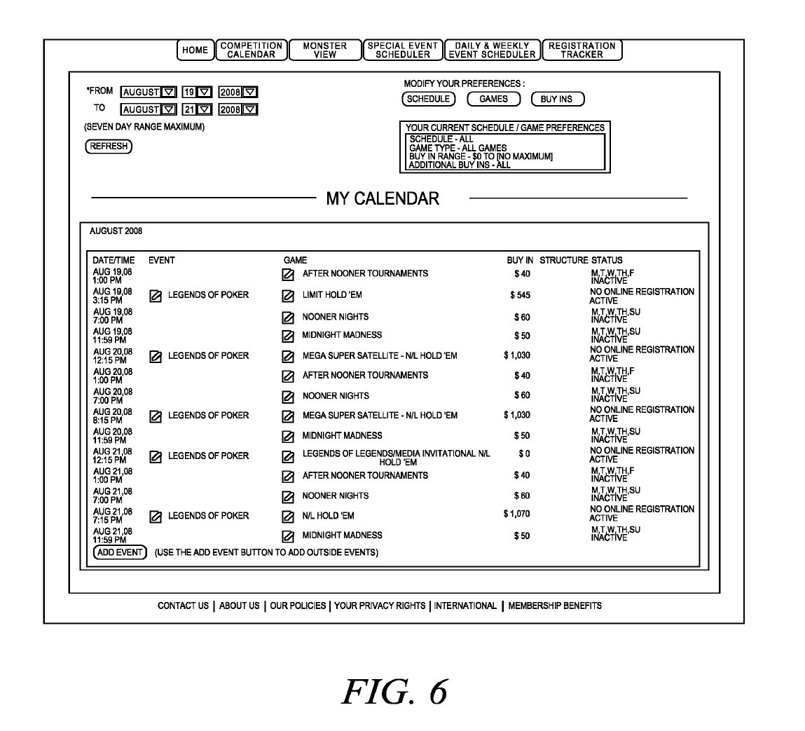

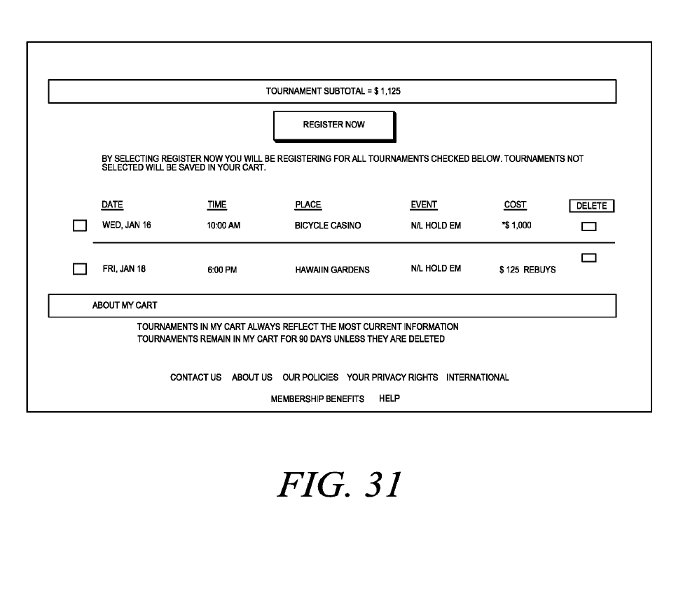

For the purpose of the understanding, figures including FIG. 6 to FIG. 34 show a website for managing schedules of a plurality of casino tournaments, in accordance with an embodiment of the present invention. The website is provided by the system 102.

FIG. 6 to FIG. 21 are exemplary web pages accessed by the casino member 106 demonstrating one the web pages present in the website provided by the system 102.

FIG. 6 illustrates a casino home page of the casino member 106, in accordance with an embodiment of the present invention. The casino home page is a default webpage of the casino member 106. The casino home page is accessed after the casino member 106 logs into the website using a log-in link from a non-member home page. The figure shows a ‘My Calendar’ section of the casino home page, where the ‘My Calendar’ section displays the current month and the casino tournaments that the casino member 106 has scheduled through the website. The ‘My Calendar’ section can also include personal events that are manually added by casino member 106. The casino home page can be viewed as a standard calendar or a list. In FIG. 6, it is shown in the list view. A default view is a setting in the casino member 106 profile. Further, the calendar can be printed, and will print in either a calendar format or list format, depending upon the calendar view the casino member is using.

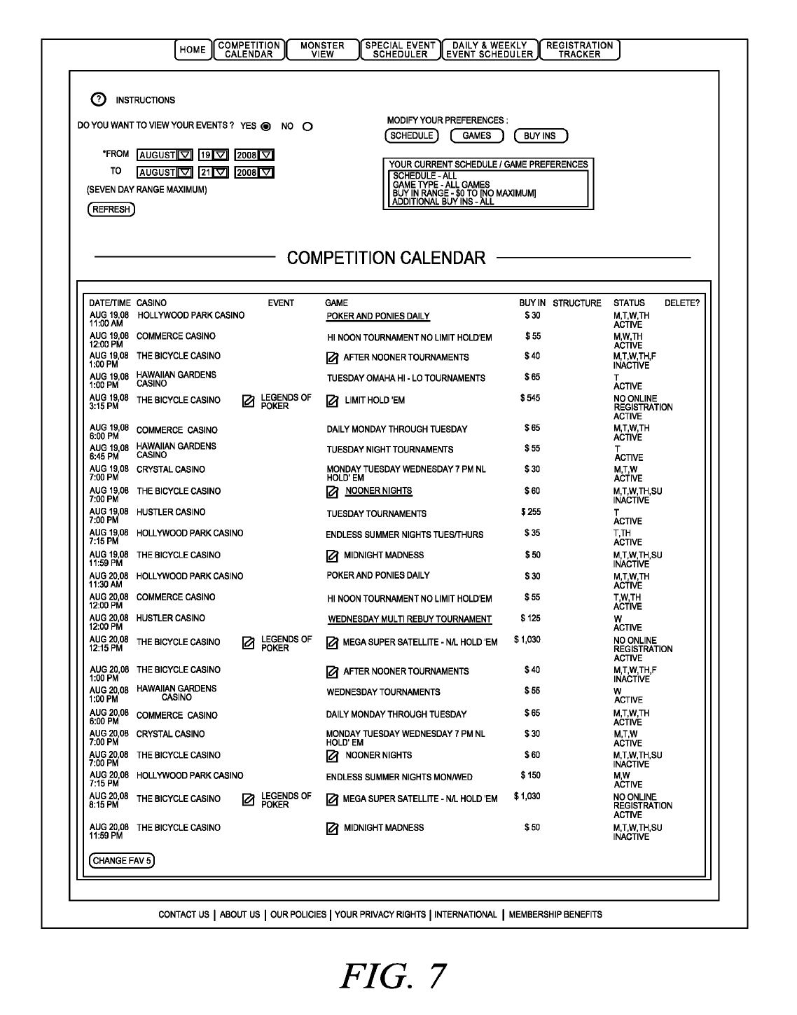

FIG. 7 illustrates a view of the competition calendar of the casino member 106, in accordance with an embodiment of the present invention. The competition calendar allows the casino member 106 to view a schedule of the one or more competing casinos. The competition calendar can display the events of the casino member 106 and the one or more competing casinos to allow for better scheduling decisions.

The casino member 106 selects the competitor calendar settings in its profile. The competition calendar can be set to either a calendar view or a list view. The competition calendar can also filter by game type, schedule, and buy in amount.

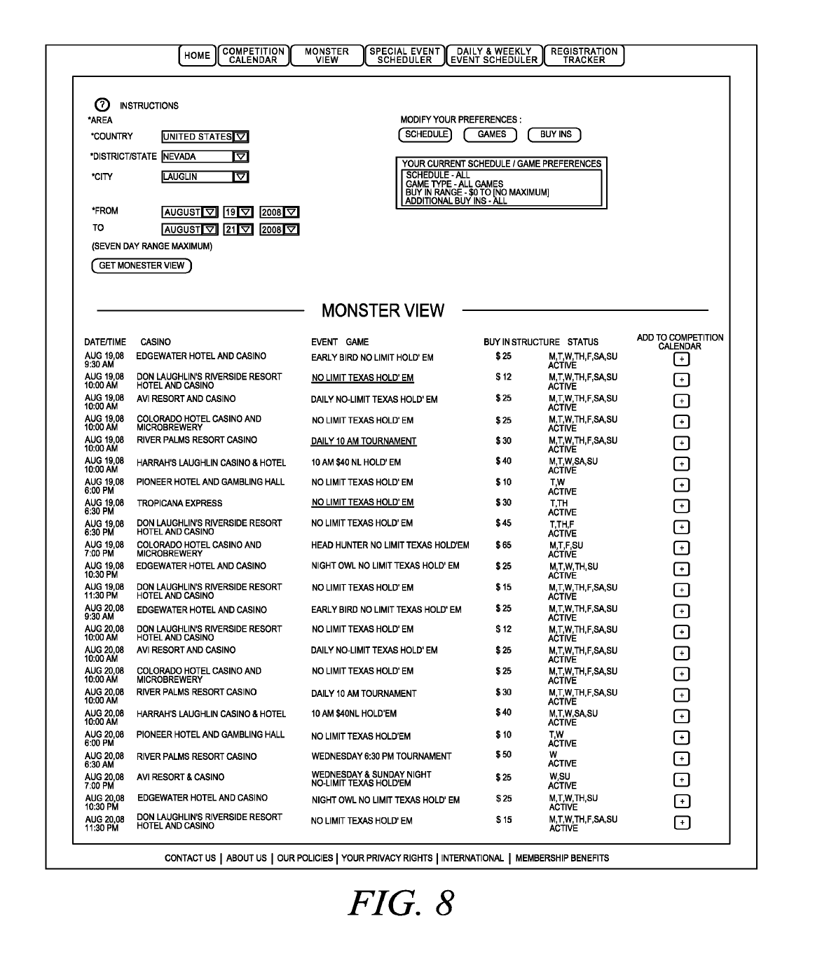

FIG. 8 illustrates a casino monster view page of the casino member 106, in accordance with an embodiment of the present invention. The casino monster view page is used by the casino member 106 to perform an extensive search for the one or more casino tournaments from all over the world. The casino monster view page is designed to show the casino member 106 as much information as possible all in one place. The one or more casino tournaments search can be run for one or more of a location and a date. Further, the casino monster view page allows one or more functions to narrow the search results by one or more of a schedule type, a game type and tournament cost. The schedule type can be one of a daily schedule, a weekly schedule and a monthly schedule.

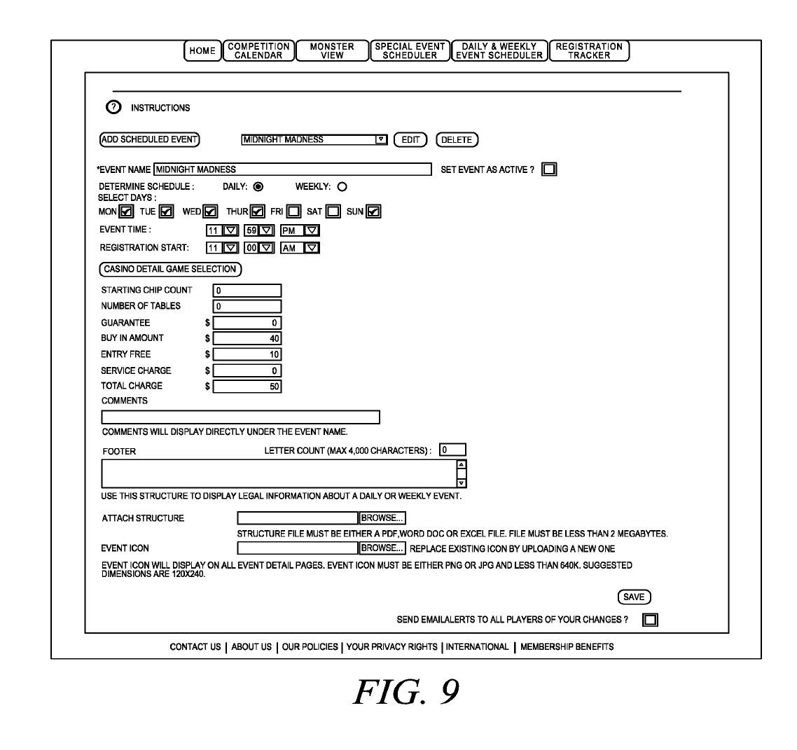

FIG. 9 illustrates a daily and weekly event scheduler page for the casino member 106, in accordance with an embodiment of the present invention. The events of the casino member 106 include casino tournaments, special events and personal events of the casino member 106. The daily and weekly event scheduler is used to modify one of a daily event and a weekly event.

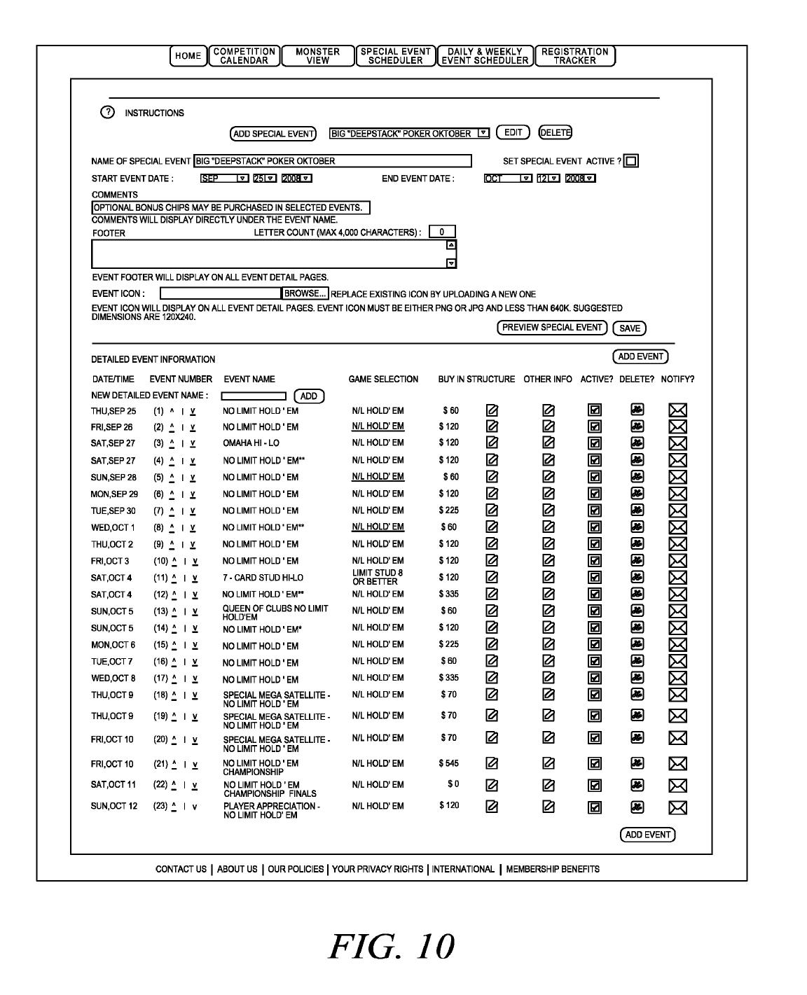

FIG. 10 illustrates a special event scheduler page for the casino member 106, in accordance with an embodiment of the present invention. The figure includes a section 1002 and a section 1004. The special event page is used to add a special event. The special event will always have an associated detailed event. The section 1002 in the special event page allows modification of the information of the special event. The section 1004 of the special event page displays the detailed event information.

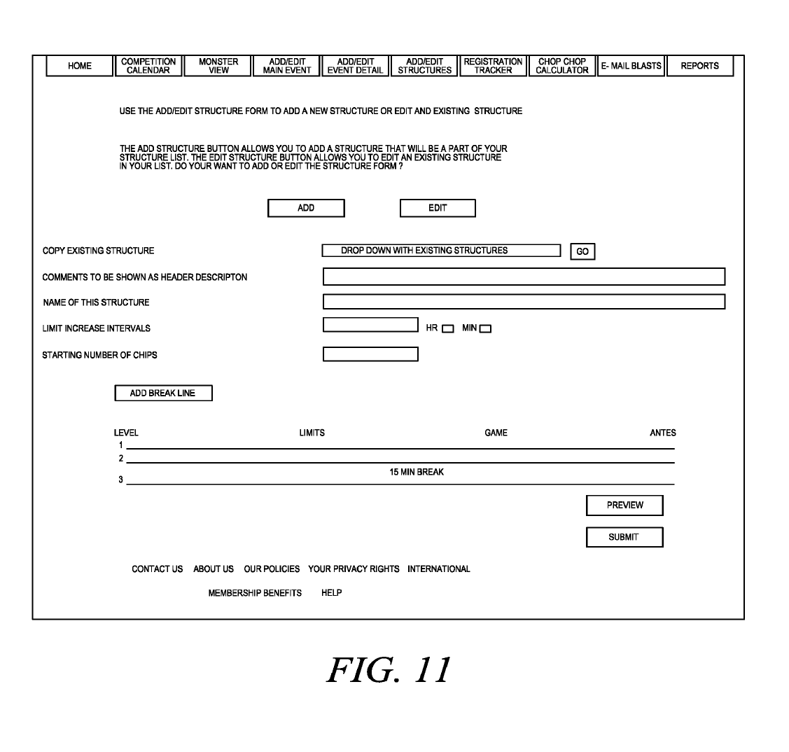

FIG. 11 illustrates an ‘Add/Edit structure’ form for the casino member 106, in accordance with an embodiment of the present invention. The “Add/Edit Structure” form can be used to add a new structure or edit an existing structure.

Initially, the casino member 106 is provided with eight template structures that can be used in creating one or more new structures. The casino member 106 picks a structure to copy and the structure is linked to a form that matches the structure. All values from template structure are copied into the new structure, and from there, the casino member 106 modifies one or more fields and values and saves the new structure.

The template structure is unique with different number of columns and/or layout. The template structure will be setup and maintained by a system administrator. The casino member 106 cannot edit the template structure. The casino member 106 builds the new structure using the template structure and names them.

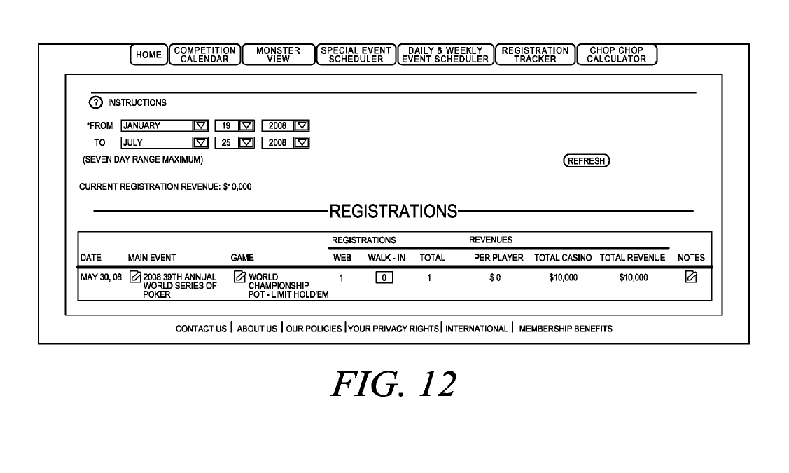

FIG. 12 illustrates a registration tracker page for the casino member 106, in accordance with an embodiment of the present invention. The registration tracker page allows the casino member 106 to track online registration for personal one or more casino tournaments. The personal one or more casino tournaments are the one or more casino tournaments organized by the casino member 106. The registration tracker page displays all events that are available for online registration, and provides a count on the number of the one or more players currently enrolled through the website, along with current revenues from online registration.

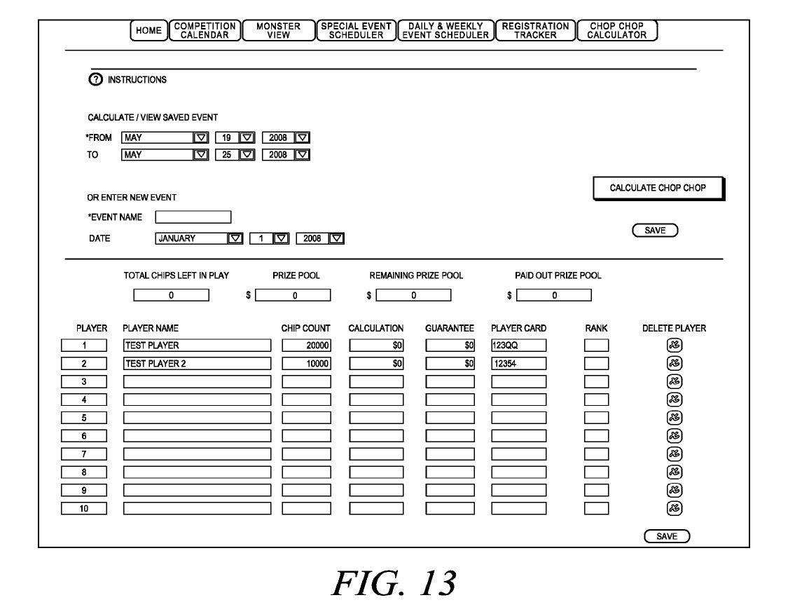

FIG. 13 illustrates a webpage of a chop-chop calculator for the casino member 106, in accordance with an embodiment of the present invention. The chop-chop calculator allows the casino member 106 to calculate a final payout and a rank for each player of a one or more participating players ready to consider a chop of the tournament money. When the one or more participating players are ready to consider the chop, the casino member 106 inputs a total event payout and a hand input already paid. Subsequently, remaining prize pool is calculated by using refresh key.

According to an embodiment of the present invention, the chop-chop calculator is capable of being printed.

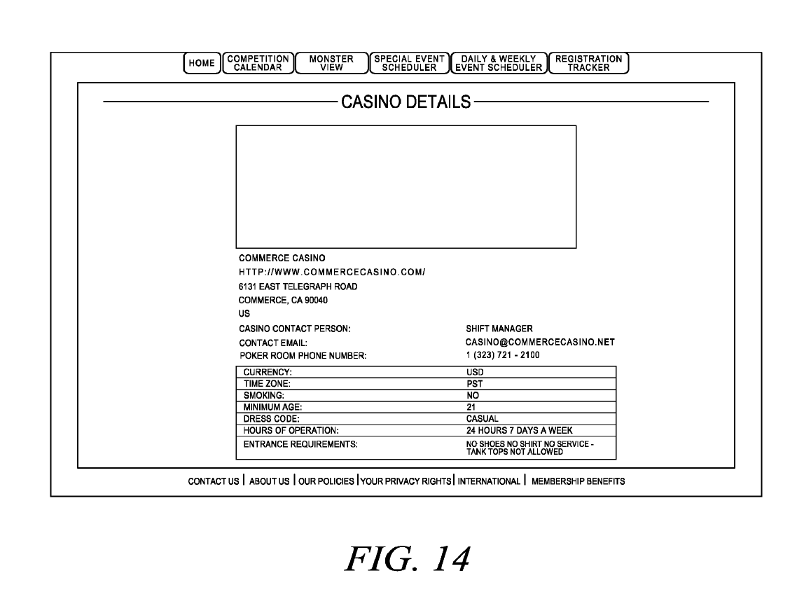

FIG. 14 illustrates a view of casino detail page for the casino member 106, in accordance with an embodiment of the present invention. The casino detail page is displayed when the player 108 clicks on a casino name in the search results obtained by the player during a search.

According to an embodiment of the present invention, the casino member 106 uploads a company logo to display on the casino detail page.

The casino member 106 can also upload a promotional document displaying as a link on the casino detail page. The promotional document can be in one of PDF format, Word format, text file format, and PowerPoint format. Other information includes one or more of a casino name, link to the casino website address, physical address, poker room phone number, contact person, hours of operation, dress code, smoking and the like.

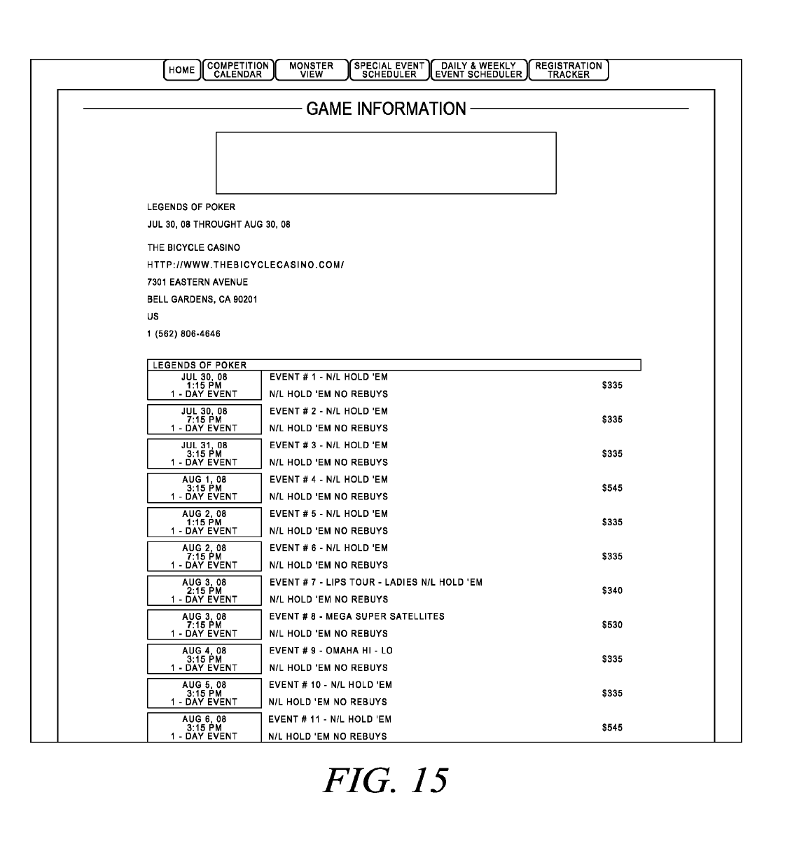

FIG. 15 illustrates a view of a special event page for the casino member 106 according to an embodiment of the present invention. The special event page is displayed each time the player 108 selects a special event name. One or more details about the special event and all associated games are displayed on the special event page. Furthermore, the special event page displays a complete tournament schedule that can be printed by the one or more player 108.

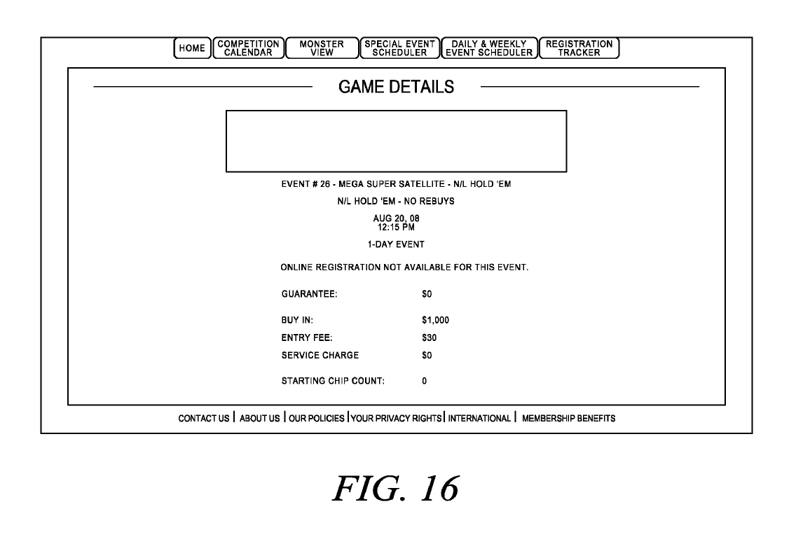

FIG. 16 illustrates a view of a game page for the casino member 106, in accordance with an embodiment of the present invention. The game page displays information of one casino tournament of the one or more casino tournaments. The information of the one casino tournament includes one or more of an entry fee, a service charge, a buy in rate starting chip count, a date, a time, a venue and seat availability.

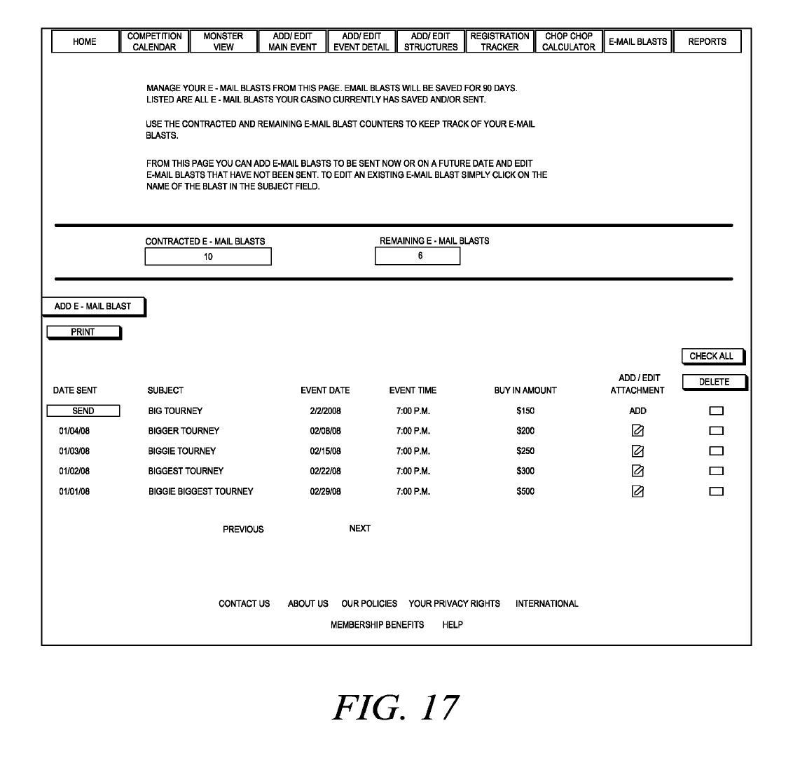

FIG. 17 illustrates a view of a casino ‘e-mail blasts’ page for the casino member 106, in accordance with an embodiment of the present invention. The casino ‘e-mail blasts’ page displays one or more marketing emails sent by the casino member 106 to the one or more players.

The one or more marketing emails will remain in the inbox of the casino member 106 for a limited time such as up to 120 days. After 120 days they are purged from the database. Further, the one or more marketing emails can be removed at any time by the casino member 106.

A counter is available on the casino ‘e-mail blasts’ page to assist the casino member 106 to manage the one or more marketing emails. The counter indicates the number of contracted one or more marketing emails and the number remaining on that contract. The one or more marketing emails can be added and edited from this page.

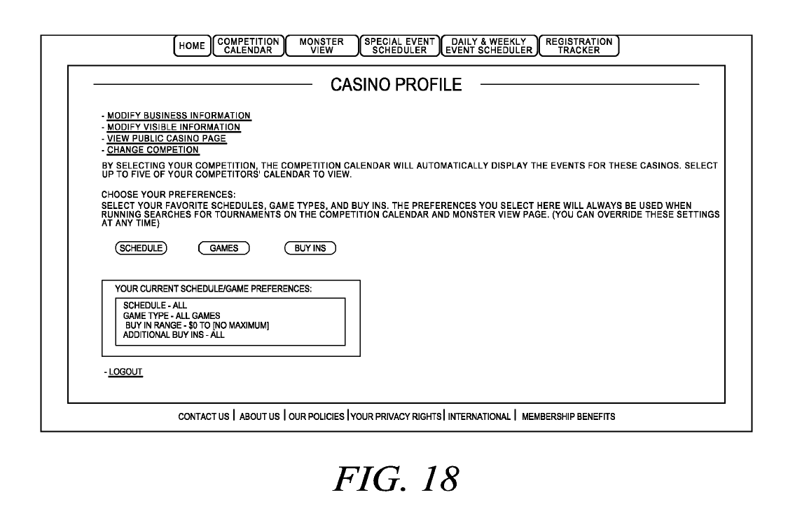

FIG. 18 illustrates a casino profile home page for the casino member 106, in accordance with an embodiment of the present invention. The casino profile home page displays information about the casino member 106. The casino profile home page shows links to plurality of profile pages and one or more game preference buttons. Examples of the plurality of profile pages include, but are not limited to, modify business information, modify visible information, view public casino Page, change competition. Examples of the one or more game preference buttons include, but are not limited to, a game home page, the competition calendar, and the monster view page.

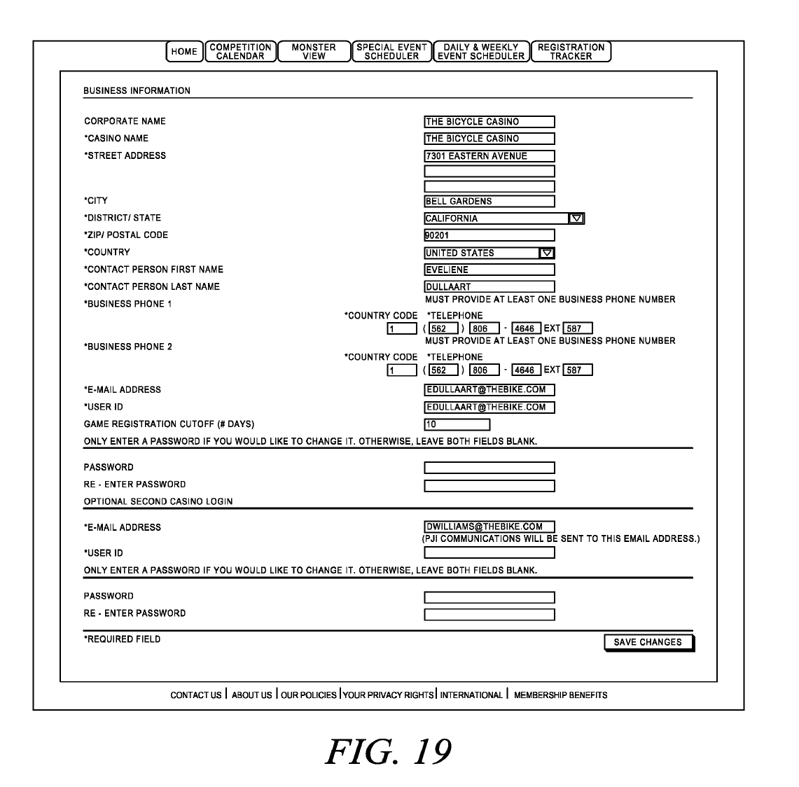

FIG. 19 illustrates a ‘modify business information’ webpage for the casino member 106, in accordance with an embodiment of the present invention. The ‘modify business information’ webpage is used to setup and store contact information of a casino represented by the casino member 106. The contact information includes one or more of a mailing address, a phone number, email addresses, a website user id and passwords. The content on this page is not viewable to other casinos or the one or more player members.

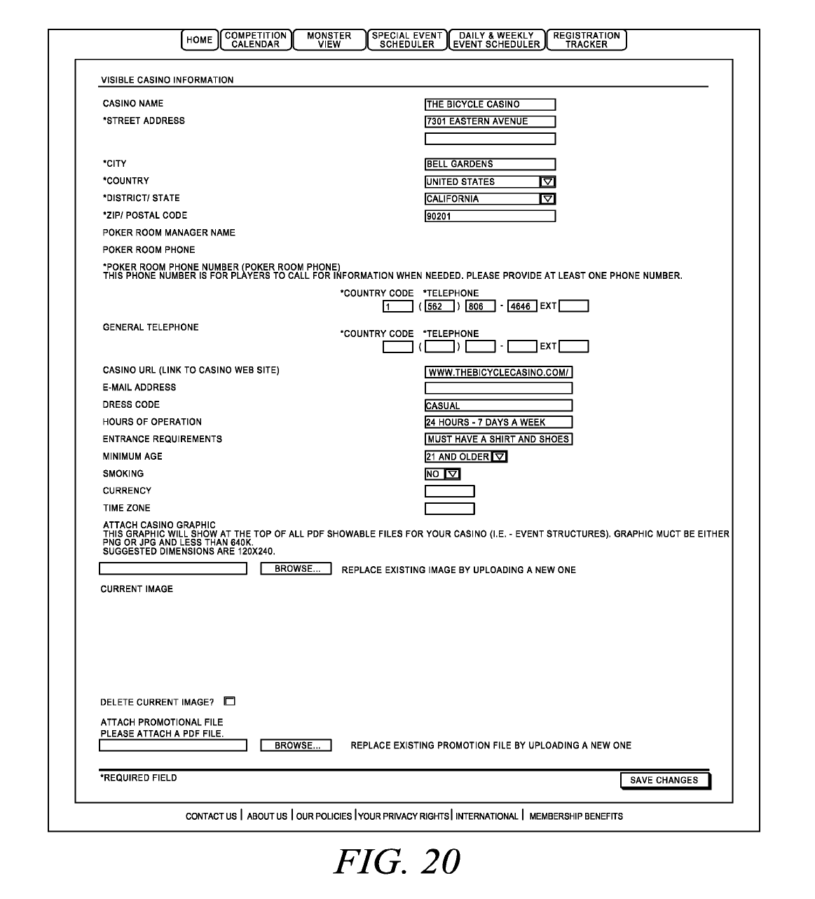

FIG. 20 illustrates a ‘modify visible information webpage’ for the casino member 106, in accordance with an embodiment of the present invention. The ‘modify visible information’ webpage is used to setup a viewable content for the casino member 106. The viewable content includes one or more of a casino name, mailing address, poker room phone number, a casino logo, a casino marketing document, hours of operation, and dress code.

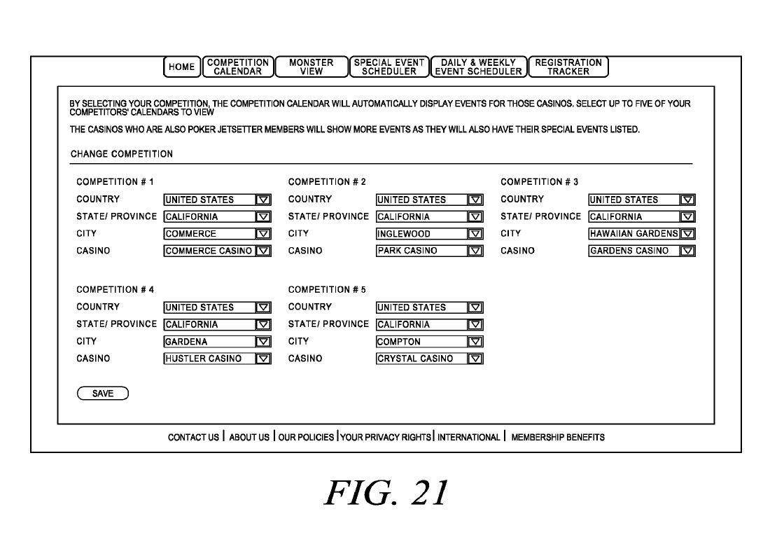

FIG. 21 illustrates a change competition webpage for the casino member 106, in accordance with an embodiment of the present invention. The change competition webpage allows the casino member 106 to select the one or more competing casinos.

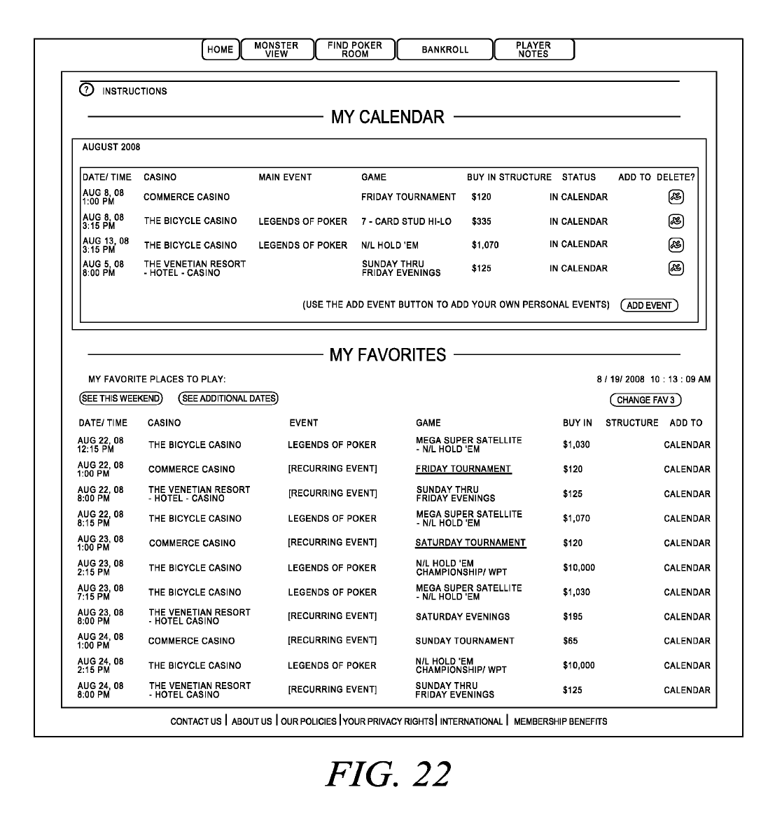

FIG. 22 to FIG. 34 discusses web pages accessed by the player 108, the web pages present in the website provided by the system 102.

FIG. 22 illustrates a player home page for the player 108, in accordance with an embodiment of the present invention. The figure shows a section 2202 and a section 2204. The player home page is the default page of player 108 and is accessed after the player 108 logs into the website using a login link from a non-member page. The section 2202 displays ‘My calendar’ with one or more current information. The one or more current information includes one or more of a current month, the selected one or more casino tournaments of the player 108, one or more casino tournaments the player 108 is interested in, casino tournaments in cart for payment and casino tournaments manually added by the player 108.

The player home page can be viewed as either a standard calendar or a list view. The section 2204 displays ‘My favorites’ section of the player home page, where the ‘My favorites’ section that displays the one or more casino tournaments occurring at one or more favorite casinos of the player 108. Further, the section 2204 displays the one or more casino tournaments scheduled to take place in the near future.

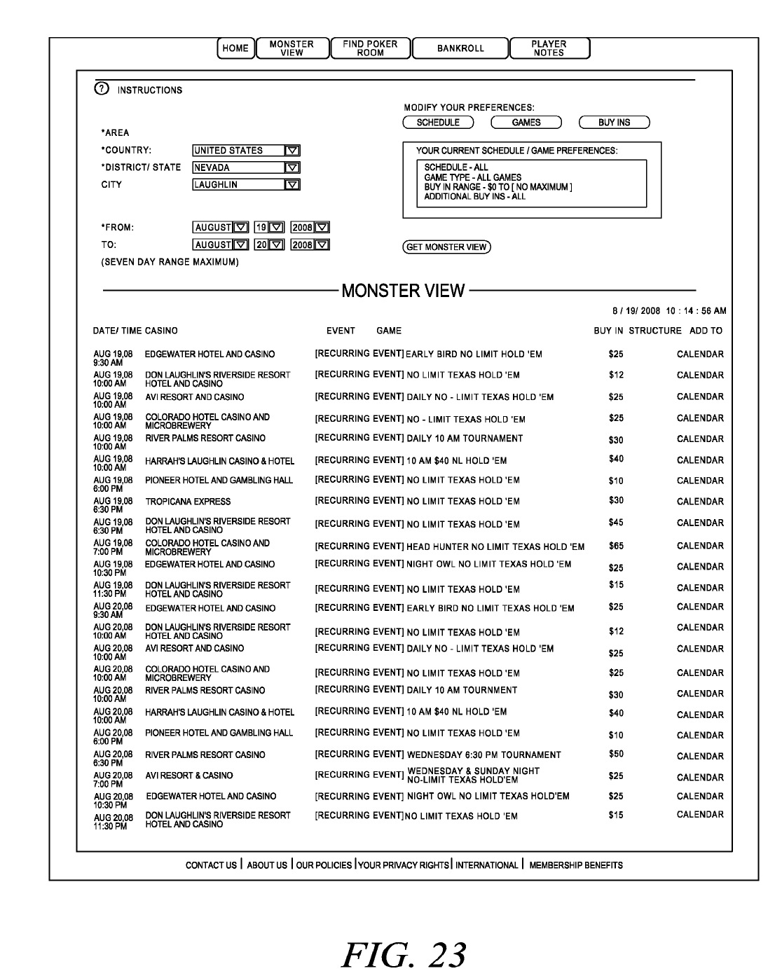

FIG. 23 illustrates a player monster view page of the player 108, in accordance with an embodiment of the present invention. The player monster view page is used by the player 108 to find a tournament. The player monster view page is designed to show the player 108 as much information as possible all in one place. The one or more casino tournaments search can be run for one or more of a location and a date. Further, the player monster view page allows one or more functions to narrow the search results by one or more of a schedule type, a game type and tournament cost. The schedule type can be one of a daily schedule, a weekly schedule and a monthly schedule.

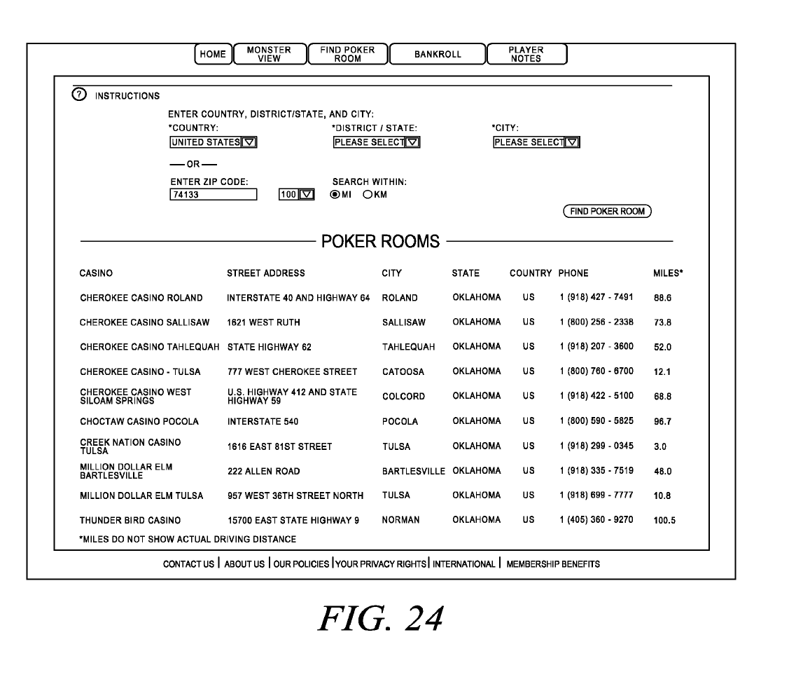

FIG. 24 illustrates a poker room webpage of the player 108, in accordance with an embodiment of the present invention. The poker room webpage is used to search one or more poker rooms. The search for the one or more poker rooms is done by specifying one or more of a country, a state, a city, a zip code and mileage range.

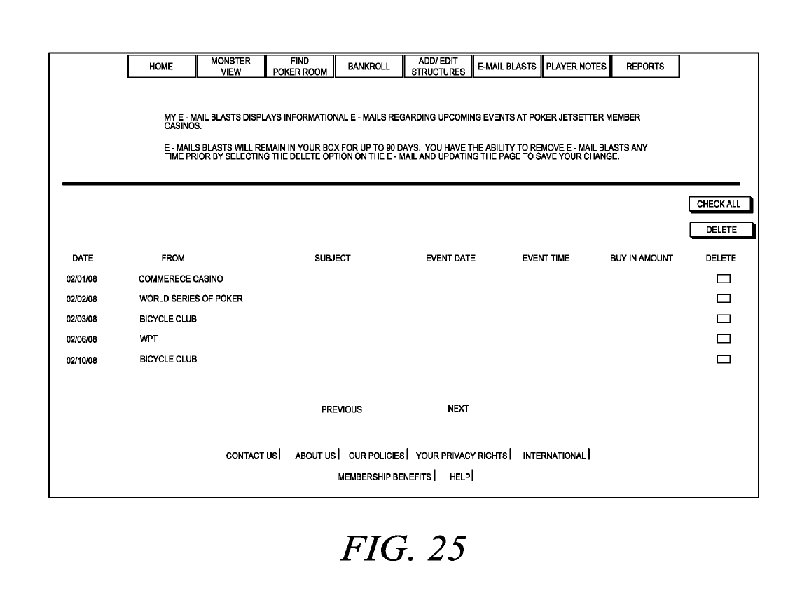

FIG. 25 illustrates a view of a ‘my e-mail blasts’ page for the player 108, in accordance with an embodiment of the present invention. The ‘my e-mail Blasts’ displays the one or marketing emails sent by the casino member 106 for the at least one of the plurality of casino tournaments. The one or more marketing emails will remain in the inbox of the player 108 until the tournament date has passed or until the player 108 deletes them.

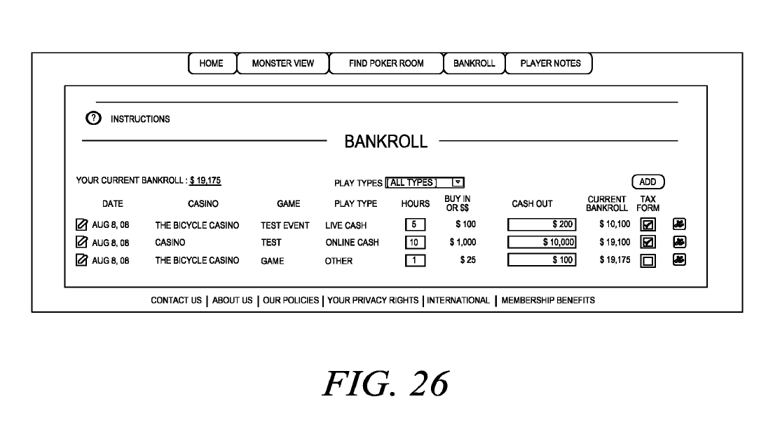

FIG. 26 illustrates a bankroll page for the player 108, in accordance with an embodiment of the present invention. The bankroll page is used by the player 108 to track the number of wins and losses. The player 108 records beginning bankroll in user profile. Subsequently, the one or more casino tournaments that the player 108 registers through the website are automatically displayed on the bankroll page.

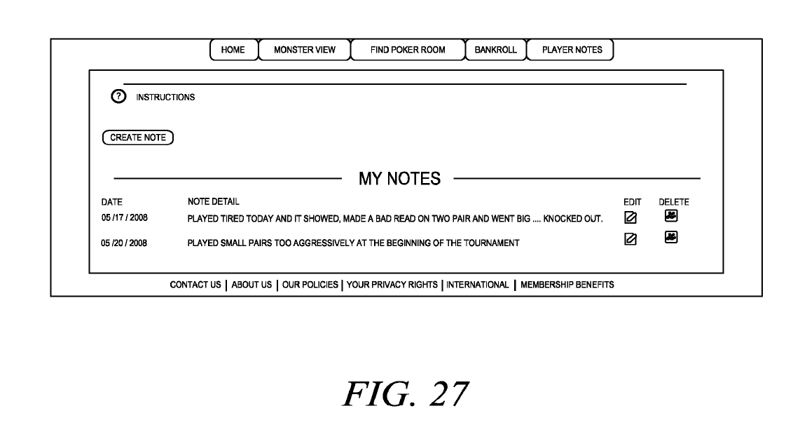

FIG. 27 illustrates a ‘player notes webpage’ for the player 108, in accordance with an embodiment of the present invention. The ‘player notes page’ is used by the player 108 to track notes of the one or more casino tournaments that the player 108 has participated in. A Create Note button opens up a pop up box where the player 108 can type a date and a note of up to 250 characters. The notes will display for as long as the player 108 would like to keep them or for a limited time such as 3 years. Check all and Delete buttons will remove the notes when selected.

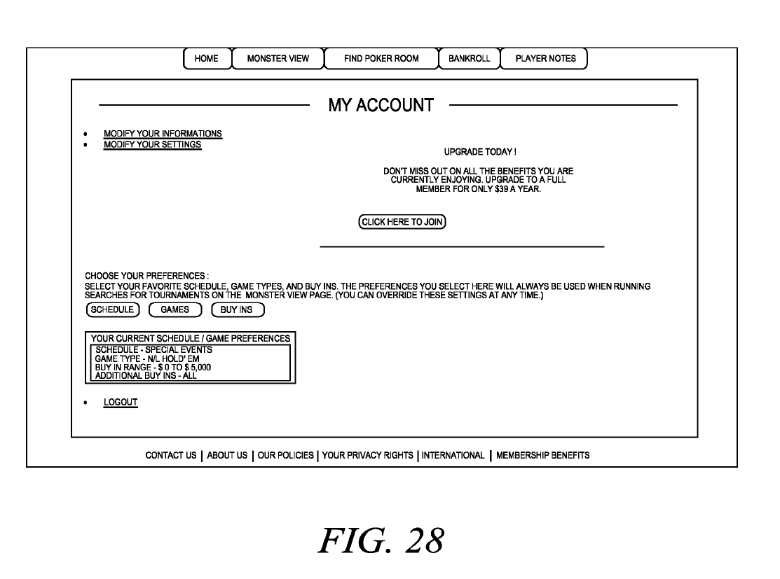

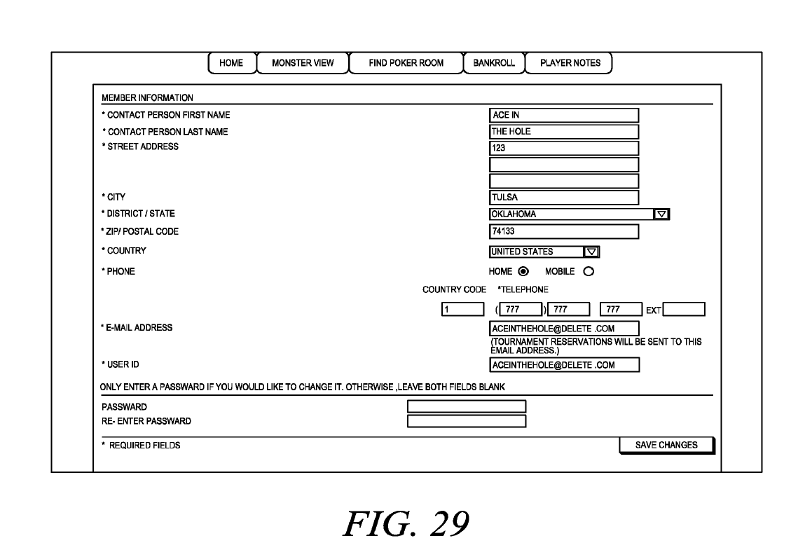

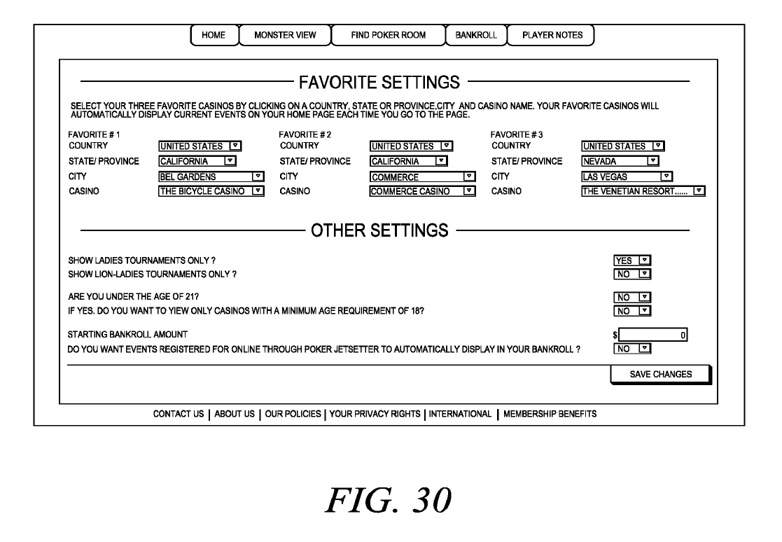

FIG. 28-30 illustrates user profile pages for the player 108, in accordance with an embodiment of the present invention. FIG. 28 shows a main page for the player 108. FIG. 29 shows a ‘Modify your settings’ page for the player 108. FIG. 30 shows a favorite page for the player 108. The user profile pages allow the player 108 to view the profile and to modify the profile.

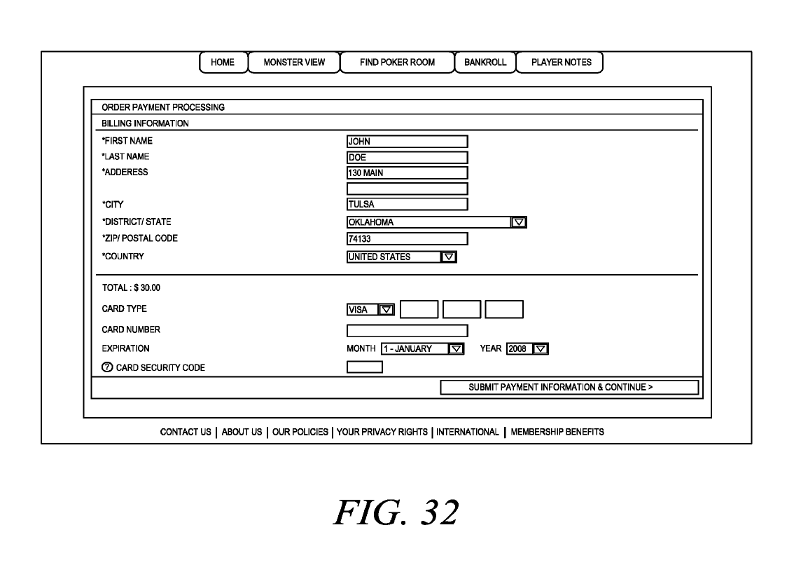

FIG. 32 shows a membership payment page for the player 108, in accordance with an embodiment of the present invention. The membership payment page allows review and payment of fees for one of a membership and the selected one or more casino tournaments.

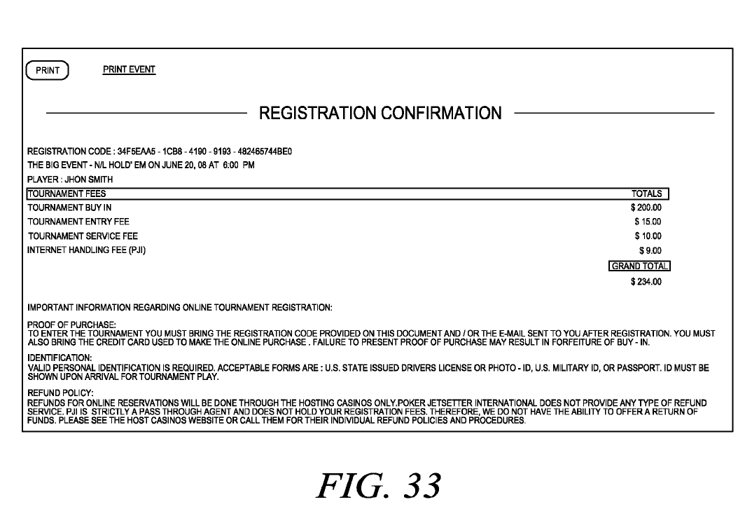

FIG. 33 shows a registration confirmation webpage for the player 108, in accordance with an embodiment of the present invention. The registration confirmation webpage is the review and payment processing page and is used to register for the one or more casino tournaments.

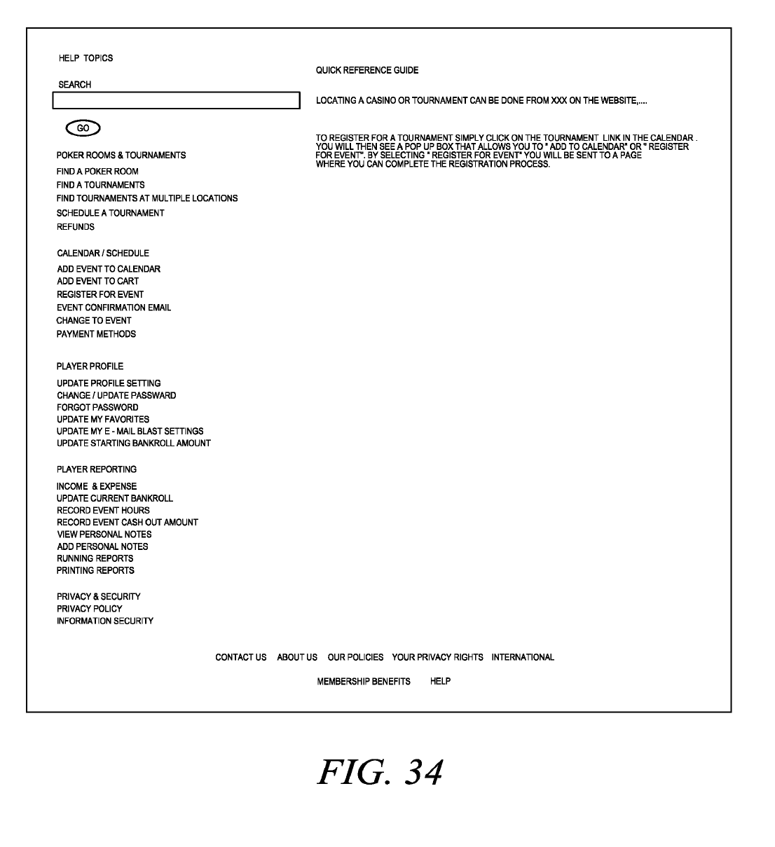

FIG. 34 shows a help webpage, in accordance with an embodiment of the present invention. The help webpage is used for functional questions on the one or more player pages.

It should be appreciated a visual display include but are limited to any device that allows the user to view any aspect of the claimed invention examples of which include but are not limited to a monitor, video screen, PDA and television.

It should also be appreciated that the various embodiments disclosed herein can incorporate one or more computing devices including, but are not limited to, a general purpose or specialty computer, a laptop, a PDA, a mobile phone, a computer readable medium, a hard drive and an embedded microprocessor and an interactive kiosk or monitor.

The invention is defined solely by the appended claims including any amendments made during the pendency of this application and all equivalents of those claims as issued.

1-13. (canceled)

14. A method for providing and scheduling one or more casino tournaments over a computer network, the method comprising:
providing one or more casino members with the ability to create an account or log-in to provide information regarding a plurality of casino tournaments over a computer network to allow one or more potential players to search for and sign up to participate as a player in one or more of the plurality of casino tournaments;
providing the one or more casino members with a log-in screen on one or more visual displays;
providing the one or more casino members with the ability to create one or more special event tournament schedules, through the a first scheduler, based on pre-specified criteria of casino tournaments information over a computer network;
providing the one or more casino members with the ability to create one or more daily and weekly event tournament schedules, through the a second scheduler, based on pre-specified criteria of casino tournaments information over a computer network;
receiving information regarding the plurality of casino tournaments including at least the start and end date, tournament type, amount of the buy in, whether or not the tournament offers a re-buy or add-on and numbers of players at each tournament table offered by a casino from the one or more casino members, the information being provided by the at least one casino member over a computer network;
providing the one or more potential players in one or more casino games of the plurality of casino tournaments with the ability to search the plurality of casino tournaments offered by the one or more casino members based on pre-specified criteria of the plurality of casino tournaments over a computer network, the pre-specified criteria being selected by the one or more potential players; and
providing the results of a search of the plurality of casino tournaments from a search requested by the one or more potential players on a visual display or computer readable medium, the results being provided based on the search requested by the one of more potential players selecting one or more pre-specified criteria regarding the plurality of casino tournaments and including at least the start and end date, tournament type, amount of the buy in, whether or not the tournament offers a re-buy or add-on and numbers of players at each tournament table;
wherein the one or more casino members create an account or register to provide casino tournament information through one of the two schedulers over a computer network at least once before receiving information regarding the plurality of casino tournaments offered by the one or more casino members from the one or more casino members; and
wherein the one or more casino members can view one or more competitor's tournament schedule.

15. The method according to claim 14, wherein the pre-specified criteria comprises one or more of a keyword, a date, a, prize, a celebrity, a month or date, a casino tournament name, a casino, a zip code, type of casino game, buy-in options, maximum number of players, format of one or more casino games offered, buy-in amount, type of game, a location and a casino name.

16. The method according to claim 14, further comprising receiving payment information over a computer network from the potential players for the potential players' participation in the plurality of casino tournaments selected by the potential player, the payment information being provided by the potential player.

17. The method according to claim 14, further comprising providing a listing for tournament schedules online that gives the one ore or more casino members the ability to view all future tournament schedules and the ability to view the one or more competitor's tournament schedule.

18. The method according to claim 14, further comprising providing a competition listing for viewing and planning of schedule of the plurality of casino tournaments by the at least one casino member.

19. A system for scheduling and providing tournament information for one or more casino tournaments, where a schedule is entered by one or more casino members through the scheduler(s) to one or more potential players for participation in the one or more events of a casino tournament, the system comprising:
at least one server having an interface for communication over a computer network to allow one or more potential players to search for and sign up to participate as a player in one or more of the plurality of casino tournaments;
a first login module, the first login module logging-in at least one casino member of the one or more casino members or at least one potential player of the one or more potential players;
a first scheduler module, the special events scheduler module to input information regarding one or more casino tournaments, the information being provided by the at least one casino member;
a second scheduler module, the daily and weekly scheduler module to input information regarding one or more daily or weekly casino tournaments, the information being provided by the at least one casino member;
an upload module, the upload module uploading the data input into the scheduler(s) modules regarding one or more casino tournaments, the information being provided by the at least one casino member;
a search module, the search module searching the plurality of casino tournaments based on a pre-specified criteria, the pre-specified criteria being provided by the at least one potential player;
a selection module, the selection module selecting the one or more casino tournaments from the search results obtained from the search module, the casino tournaments being selected by the at least one potential player; and
a registration module, the registration module allowing the one or more potential players to sign up to participate as a player in the one or more casino tournaments.

20. The system according to claim 19, further comprising a marketing module, the marketing module sending marketing information of the one or more casino tournaments to the at least one potential players, the marketing information being provided by one or more casino members.

21. The system according to claim 19, wherein the casino tournaments are poker tournaments.

22. The system according to claim 19, further comprising a first calendar module, the first calendar module providing a casino calendar for viewing and planning all future tournament schedules of the one or more casino tournaments by the one or more casino members and the ability to the one or more casino members to view the one or more competitor's tournament schedule and search and register for casino tournaments having specific characteristics directly from the calendar module.

23. The system according to claim 22, wherein the first calendar module comprises a competition calendar module, the competition calendar module providing a competition calendar for allowing the at least one casino member to view a schedule of at least one casino tournament of one or more competing casino members, the one or more competing casino members being selected from the one or more casino members.

24. The system according to claim 22, further comprising a second calendar module, the calendar module for planning of personal schedules by at least one potential player.

25. A method for providing and scheduling one or more casino tournaments, where a schedule is provided by one or more casino members to one or more players, the schedule being provided for participation in the one or more casino tournaments, the method comprising:
providing a website hosted by the at least one computer in communication with the computer network to allow one or more potential players to search for and sign up to participate as a player in one or more of the plurality of casino tournaments;
logging-in at least one casino member of the one or more casino members;
imputing tournament data into a scheduler module by the at least one casino member;
uploading information of a plurality of casino tournaments utilizing the scheduler module, through the web site, the information being provided by the at least casino member;
sending marketing information of at least one of the plurality of casino tournaments to the one or more players, the marketing information being provided by the at least one casino member.
logging-in at least one player of the one or more players through the website;
searching the plurality of casino tournaments based on a pre-specified criteria, the pre-specified criteria being provided by the at least one player on the website;
selecting the one or more casino tournaments from the search results obtained, the selection being requested by the at least one player;
scheduling the one or more casino tournaments utilizing the third player calendar from the search results obtained, the selection being requested by the at least one player;
providing the one or more potential players with the ability to sign up to participate as a player in the one or more casino tournaments; and
providing the one or more casino members with the ability to view the one or more competitor's tournament schedule.
